(19) United States
(12) Patent Application Publication
(10) Pub. No.: US 2026/0062989 A1
(43) Pub. Date: Mar. 5, 2026

(54) INTERIOR-MOUNT PROTECTIVE WINDOW COVERING WITH TOOL-LESS SECURING MECHANISM

(71) Applicant: Steven McCoy, Centereach, NY (US)

(72) Inventor: Steven McCoy, Centereach, NY (US)

(21) Appl. No.: 19/302,153

(22) Filed: Aug. 18, 2025

Related U.S. Application Data
(60) Provisional application No. 63/688,686, filed on Aug. 29, 2024.

(51) Int. Cl. E06B 9/02; E06B 9/00

(52) U.S. Cl. CPC E06B 9/02; E06B 2009/005

(57) ABSTRACT

The present invention relates to an interior-mount protective window covering system configured for tool-less installation from within a building. The system includes a panel dimensioned to fit within a window frame and a plurality of securement members extendable from the panel to engage interior surfaces of the frame. Various securing mechanisms—including latch, lever, cam, rod, and tube-based configurations—enable user actuation or passive deployment of the securement members. In certain embodiments, a threshold clamp engages a windowsill to enhance vertical retention when the window is closed. The system is operable entirely from the building interior without requiring external fasteners, adhesives, or frame modifications, and accommodates non-uniform frame geometries via independent and adjustable securing mechanisms. The invention enables safe, rapid, and reversible deployment of protective panels for storm protection, debris shielding, or security enhancement, while preserving window operability and aesthetics.

### CROSS-REFERENCE TO RELATED APPLICATIONS

This application contains subject matter that is related to the subject matter of the following co-pending application. The below-listed application is hereby incorporated herein by reference in its entirety:
This is a U.S. non-provisional application that claims the benefit of a U.S. provisional application, Ser. No. 63/688,686, inventor Steven McCoy, entitled “Protective Window Covering”, filed Aug. 29, 2024.

### TECHNICAL FIELD OF THE INVENTION

This invention relates to interior-mount protective systems for windows, and particularly to tool-less, user-installable window covering systems that secure a rigid or semi-rigid panel within a window frame using mechanical securing mechanisms actuated entirely from within the building. The invention encompasses various actuation configurations—including lever, latch, rod, cam, and spring-driven systems—designed to extend and retract securement members without requiring exterior access, frame modification, or permanent fasteners.

### BACKGROUND OF THE INVENTION

Before our invention, various approaches were developed to provide protective barriers or coverings for residential and commercial windows, particularly for use during storms or other events requiring temporary structural reinforcement. However, these prior approaches exhibited numerous shortcomings that limited their effectiveness, usability, and adoption.

Many traditional solutions required exterior access to the window for installation or removal. This constraint made them impractical or unsafe for multi-story buildings, apartments, and other structures where outdoor access is limited or prohibited. Even in single-family homes, installing from the outside exposed users to risks from ladders, weather conditions, and falling debris. Approaches that required fastening from the outside could also pose compliance and liability issues in rented or shared properties.

Another common shortcoming of earlier systems was the need for permanent structural modifications. Many relied on screw-in anchors, bolts, or adhesives that damaged the window frame, sill, or wall surface. These modifications not only altered the aesthetics of the building but also reduced property value and conflicted with building codes or lease agreements. Removing such systems often left visible marks or required professional repair.

Other solutions failed to accommodate the variability of real-world window geometry. Window frames are frequently out-of-square, uneven, or built with inconsistent tolerances. One-size-fits-all designs, rigid templates, or compression-fit panels often failed to form an adequate seal or maintain a secure fit across different installations. As a result, these systems were prone to rattling, air leakage, or complete dislodgment under stress.

Additionally, many prior systems were difficult for an average user to install or adjust without assistance. Complex alignment procedures, tight tolerances, or poorly designed actuators made deployment time-consuming and error-prone. In urgent situations such as storm preparation, these limitations led to delays, frustration, or outright failure to deploy the protective system.

The present invention addresses these and other shortcomings by providing a secure, modular, and tool-less protective window covering that mounts entirely from the building interior and accommodates frame variability without requiring permanent modification. For these reasons and shortcomings, as well as other reasons and shortcomings, there is a long-felt need that gives rise to the present invention.

### SUMMARY OF THE INVENTION

The shortcomings of the prior art are overcome, and additional advantages are provided through the provision of an interior-mount protective window covering system configured for tool-less installation entirely from within a building. The system includes a panel sized and shaped for insertion into a window frame from the structure's interior-facing side, eliminating the need for exterior access, tools, or permanent modifications. A plurality of securement members are slidably mounted along the panel's lateral sides and are extendable from retracted to extended positions to engage the interior surfaces of the window frame and retain the panel securely in place. At least one securing mechanism is operatively coupled to the securement members and configured to convert user input—such as lever actuation or mechanical translation—into controlled movement of the securement members. A handle integrated into the panel provides the user with a grip point to insert, adjust, or remove the panel with ease, supporting fast, safe, and reversible deployment.

Additional shortcomings of the prior art are overcome, and additional advantages are provided through the provision of an interior-mount protective window covering system configured for tool-less installation entirely from within a building. The system includes a panel designed to fit securely within a window frame from the interior-facing side of a structure, enabling safe and convenient placement without exterior access or permanent alterations. A plurality of securement members are positioned along opposing lateral sides of the panel and are configured to extend or retract for selective engagement with the window frame. A pair of rods is provided, with each rod operatively linking at least two securement members on a common side of the panel to ensure synchronized movement and even pressure distribution. A positioning lever is coupled to at least one of the rods and is configured to actuate the linked securement members between retracted and extended positions, facilitating quick, reliable, and user-friendly installation and removal

Additional shortcomings of the prior art are overcome, and additional advantages are provided through the provision of an interior-mount protective window covering system configured for tool-less installation from within a building. This system comprises a panel sized to fit within a window frame from the structure's interior-facing side, eliminating the need for exterior access or permanent hardware. A pair of opposing securement members is disposed along the lateral sides of the panel, configured to engage with the window frame to retain the panel in position. A hollow tube extends laterally through or behind the panel and mechanically links both securement members. Contained within the tube is a spring and plunger assembly configured to bias the securement members outward automatically, providing secure retention without manual adjustment. A handle or actuator is operatively coupled to the plunger assembly and allows a user to retract the securement members, enabling smooth, tool-less insertion and removal of the panel from the window frame.

Additional features and advantages are realized through the techniques of the present invention. Other embodiments and aspects of the invention are described in detail herein and are considered a part of the claimed invention. For a better understanding of the invention with advantages and features, refer to the description and the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of installing a protective window covering in a window.

FIG. 2 illustrates one example of placing a securement member in a retracted position and in an extended position;

FIGS. 3-6 illustrates one example of a protective window covering having a cam configured securing mechanism;

FIGS. 7-10 illustrates one example of a protective window covering having a rotatable or pivotable lever (repositionable lever) configured securing mechanism;

FIG. 11-14 illustrates one example of a protective window covering having a rod configured securing mechanism;

FIG. 15-18 illustrates one example of a protective window covering having a latch configured securing mechanism;

FIG. 19-22 illustrates one example of a protective window covering having a tube configured securing mechanism;

FIG. 23-25 illustrates one example of a protective window covering having a latch configured securing mechanism;

FIG. 26 illustrates one example of a securement member 108 motion along an adjustment slot; and

FIG. 27 illustrates one example of a latch configured securing mechanism.

The detailed description explains the preferred embodiments of the invention, together with advantages and features, by way of example, with reference to the drawings.

### DETAILED DESCRIPTION OF THE INVENTION

Protecting windows during severe weather events such as hurricanes or windstorms remains a persistent challenge, particularly for residential and multi-story buildings where exterior access to windows is limited or dangerous. Prior attempts to address this problem have included permanent solutions like hurricane-rated laminated glass and exterior-mounted storm shutters, as well as temporary solutions such as plywood panels or magnetically affixed window covers. These approaches, while functional in some contexts, present various shortcomings in safety, cost, adaptability, and ease of use.

Permanent solutions, such as hurricane impact glass, require substantial construction effort and cost, and they are only viable during new construction or major renovations. Moreover, once installed, such systems cannot be removed or upgraded without replacing the entire window assembly. Similarly, traditional exterior-mounted storm shutters typically require installation from the outside, exposing the installer to adverse weather conditions and creating accessibility challenges, especially in multi-story buildings or for individuals with limited mobility. Temporary solutions like plywood boards demand tools, physical strength, and advanced planning. These panels are difficult to size correctly, often damage the building exterior, and may fail to secure effectively against the window frame without custom fasteners or additional hardware.

The present invention addresses these limitations by providing a protective window covering system that is fully mountable from the interior of a building. The system is configured for tool-less installation and removal, allowing any user—regardless of physical ability or exterior access—to rapidly deploy a protective barrier across a window. This is achieved through a panel and a set of integrated, extendable securement members, which engage laterally with the interior edges of the window frame. These securement members are actuated via a securing mechanism integrated into the panel itself, and the user applies or releases the securing force entirely from inside the room. In preferred embodiments, the system further includes a threshold clamp that engages the windowsill or window sash to prevent vertical movement or tilting of the panel when the window is closed.

What sets this invention apart is not only its interior-mount and tool-free configuration, but also its modularity and structural flexibility. The system accommodates multiple securement mechanism variants—such as latch, cam, rod-linked, lever-driven, and tube-coupled designs—each providing a distinct mechanical approach to extend or retract the securement members. Despite this variation, all embodiments retain the core function of securing a protective panel within a window frame from inside the building.

The panel itself may be fabricated from a range of materials selected to balance strength, weight, transparency, cost, and user handling characteristics. In one embodiment, the panel comprises a lightweight polymer such as polycarbonate, acrylic (PMMA), or high-density polyethylene (HDPE). These materials provide shatter resistance, UV stability, and moderate rigidity while remaining light enough for tool-free handling by a typical user. In another embodiment, the panel is constructed from a rigid composite, such as a foam-core plastic laminate or a fiberglass-reinforced sheet, which offers enhanced structural stiffness while maintaining a low overall weight.

For high-risk environments, such as hurricane-prone coastal regions, the panel may be formed from laminated impact-rated glass. This configuration typically includes two or more sheets of annealed or tempered glass bonded with a polymer interlayer, such as polyvinyl butyral (PVB) or SentryGlas. The interlayer prevents fragmentation upon impact and allows the panel to remain intact even when subjected to flying debris or pressure differentials. Panels formed from such glazing materials may comply with hurricane protection standards such as ASTM E1996, ASTM E1886, or Florida Building Code specifications. This embodiment enables a hybrid protection model: the user benefits from the structural resilience of hurricane glass while retaining the removability and flexibility of an interior-mounted system.

In some configurations, the panel may be constructed from natural or engineered wood materials. These may include plywood, hardwood panels, medium-density fiberboard (MDF), or laminated veneer lumber (LVL). Wood panels provide a cost-effective and widely available option for users who prioritize rapid deployment, affordability, or aesthetic compatibility with existing window trim or interior décor. While wood may not offer the same impact resistance as laminated glass or polycarbonate, it can still provide meaningful protection against airborne debris and wind pressure, particularly when used in combination with the interior securement system described herein. Additionally, wood-based panels may be finished, painted, or sealed to improve moisture resistance and reusability.

In other embodiments, the panel may incorporate multi-layer constructions, such as an impact-resistant polymer skin over a cellular core or aluminum substrate, to enhance rigidity and strength-to-weight ratio. Decorative or functional coatings may be applied to any panel variant to provide solar control, visual privacy, or improved integration with interior finishes. Thermal or acoustic insulating films may also be included, as may low-emissivity (low-E) coatings for year-round energy efficiency.

Regardless of material, the securing mechanisms and securement members are positioned entirely within or adjacent to the inner surface of the panel. This internalized configuration preserves a clean perimeter and ensures that no component protrudes beyond the edge of the panel or engages the exterior of the window frame. Such geometry is essential for compatibility with narrow window cavities, recessed sill designs, and building facades where external modification is restricted or prohibited.

Accordingly, the invention's material adaptability and spatial layout allow it to be deployed in a wide variety of structural environments, from conventional single-family homes to high-rise apartments and commercial buildings requiring code-compliant, non-invasive window protection. This spatial configuration is essential for compatibility with window types found in high-rise apartments, hurricane zones, and retrofit applications. The panel is preferably sized to fit within the inner perimeter of the window frame and includes securement members along both the left and right lateral edges. Each securement member moves along a constrained path defined by guide pins and adjustment slots. In some embodiments, these slots are positioned diagonally along the securement member and slide over fixed guide pins anchored to the panel, allowing the securement member to move outward and upward simultaneously. This geometry enables firm lateral engagement with the window frame while conserving space and minimizing complexity.

In an exemplary embodiment, the interior-mount protective window covering system can be configured to take advantage of the existing screen locking channel within a conventional window frame. By dimensioning and aligning at least a portion of the panel's 102 perimeter or the securement members 108 to interface with the screen locking channel, the system utilizes a pre-existing structural feature of the window frame as a mechanical retention interface. This engagement not only enhances lateral stability and resistance to inward or outward displacement but also eliminates the need for permanent modifications to the window frame. The use of the screen locking channel as part of the retention strategy further provides a concealed and aesthetically integrated means of securing the panel, making it less obtrusive and more compatible with existing architectural elements. Unlike systems that rely solely on compression against smooth frame surfaces, this configuration adds a geometric interlock that resists shifting under pressure or vibration.

In an exemplary embodiment, the system can be adapted for exterior-mounted installations where interior access is limited or impractical. Such configurations may be particularly beneficial for fixed-pane picture windows, casement windows, or awning windows, where conventional interior mounting is obstructed by hardware, trim, or interior architectural elements. In these variations, the securement members 108 and securing mechanisms 126 can be reconfigured to extend outwardly in a direction suited for exterior frame contact, and materials can be selected to withstand prolonged exposure to weather, UV radiation, and temperature fluctuations. The threshold clamp 122 and magnetic coupler 134 may be substituted with weather-sealing flanges, exterior-grade locking tabs, or other fastening means suited for exterior environments, while still preserving the core tool-less installation and removal advantages.

In an exemplary embodiment, the system can incorporate interchangeable securing mechanism modules, enabling a single panel to be fitted with latch-configured, rod-linked, cam-actuated, or tube-spring mechanisms depending on installation conditions. This modularity allows a homeowner or installer to configure the panel for either interior or exterior installation without replacing the entire panel. For example, a panel initially set up for interior use in a sliding sash window could be reconfigured with weather-sealed exterior-grade securing members for a casement window during seasonal changes or specific use cases.

In an exemplary embodiment, the panel and securement members can be dimensioned and shaped for direct engagement not only with the screen locking channel but also with other architectural recesses, ridges, or grooves present in various window designs. This allows the invention to adapt to differing manufacturer tolerances, irregular frame geometries, or historic window constructions while maintaining secure retention without drilling or adhesive bonding. By leveraging existing frame geometry for retention, the system can achieve a higher degree of mechanical stability and reduce reliance on high-torque extension forces, improving ease of installation for the user 402 while maintaining strength in both interior and exterior applications.

In an exemplary embodiment, the system can be configured to provide integrated storm protection. The panel may be constructed from impact-resistant materials such as laminated polycarbonate, multi-layer composite panels, or reinforced metal alloys capable of withstanding windborne debris impacts in severe weather events. When engaged with the securement members 108 and, in some configurations, the screen locking channel, the system can resist uplift, flexure, and displacement caused by high wind pressures. Optional gasketing or weather seals along the perimeter of the panel can further improve water intrusion resistance during driving rain, enabling the system to function as a temporary or seasonal hurricane or storm shield without requiring permanent shutters or exterior mounting hardware.

In an exemplary embodiment, the system can be configured to provide seasonal energy efficiency benefits. By selecting panel materials and coatings that offer low thermal conductivity or include reflective surface treatments, the installed system can reduce heat gain during summer months and heat loss during winter months. This thermal barrier effect can be further enhanced by the seal 110 and threshold clamp 122, which reduce air infiltration between the panel and the window frame 202. For example, a clear low-emissivity (low-E) panel could be installed during winter to retain interior warmth while still allowing natural light, while a tinted or reflective-coated panel could be installed in summer to reduce solar heat gain. This adaptability not only provides comfort benefits but also reduces HVAC load, leading to potential energy savings for the building occupant.

Through its versatile architecture, the invention overcomes the primary limitations of traditional storm protection methods. It eliminates the need for ladders, drills, or exterior installation. It accommodates both temporary and semi-permanent use. It supports a variety of securement modes to address user preferences, cost constraints, and installation conditions. And critically, it enhances safety by allowing residents to protect windows without exposing themselves to hazardous weather or exterior risks.

In operation, the present invention delivers an interior-accessible, structurally adaptable, and user-friendly window protection system, well-suited to the demands of modern residential, commercial, and emergency applications.

In the present invention, the term “building” is intended to mean any permanent or semi-permanent human-occupied structure that includes at least one window suitable for receiving the protective window covering system described herein. This includes, without limitation, single-family homes, multi-family residences (such as apartments, condominiums, and townhouses), commercial buildings (such as offices, retail spaces, and restaurants), institutional facilities (such as schools, hospitals, and government buildings), industrial structures, garages, sheds, and other types and/or kinds of suitable structures.

In the present invention, the term “panel” is intended to mean a generally planar structural element configured to be inserted into a window frame for the purpose of providing protection, coverage, or barrier functionality, without requiring permanent modification to the building.

In the present invention, the term “securement member” is intended to mean a movable element configured to extend or retract relative to the panel and make contact with the interior surfaces of a window frame, thereby securing the panel in place through friction or mechanical engagement.

In the present invention, the term “securing mechanism” is intended to mean a structural and/or mechanical assembly that translates user input into movement of one or more securement members between retracted and extended positions.

In the present invention, the term “interior-mount” is intended to mean a configuration in which the entire installation of the panel and its securing components is performed from inside a building, without requiring access to the external facade or exterior portions of the window.

In the present invention, the term “positioning lever” is intended to mean a manually actuated handle, tab, or toggle structure that is operatively linked to a securing mechanism to facilitate movement of securement members.

In the present invention, the term “threshold clamp” is intended to mean a lower structural component that passively engages a windowsill or interior ledge to improve vertical retention and alignment of the panel when the window sash is closed.

In the present invention, the term “latch ring” is intended to mean a fixed structural component secured to the panel that provides a mating interface for a latch or other locking element of the securing mechanism.

In the present invention, the term “frame adjust” is intended to mean an adjustable interface or coupling structure that allows selective positioning of a securement member relative to the window frame to accommodate different frame geometries or tolerances.

In the present invention, the term “tool-less installation” is intended to mean installation of the system without the use of external tools such as screwdrivers, drills, adhesives, or fasteners, relying instead on integrated mechanical features and manual user manipulation.

In the present invention, the term “spring and plunger assembly” is intended to mean a biasing mechanism housed within a tube or similar structure, configured to use stored mechanical energy—such as from a spring—to drive one or more securement members inward or outward. The assembly operates passively unless actively engaged or counteracted by the user.

In the present invention, the term “window frame” is intended to mean the structural cavity or opening into which a window assembly is fitted, including vertical and horizontal inner surfaces that may contact the panel or securement members when installed.

In the present invention, the term “user” is intended to mean a person located within the building or structure who installs, removes, or adjusts the protective window covering system using manual input and without tools.

In the present invention, the term “tube-configured securing mechanism” is intended to mean a securing mechanism in which opposing securement members are biased outward using a spring-loaded plunger system contained within a horizontally oriented hollow tube.

In the present invention, the term “latch-configured securing mechanism” is intended to mean a securing mechanism that includes a latch element configured to slide or pivot into engagement with a latch ring to lock a securement member in the extended position.

In the present invention, the term “rod-configured securing mechanism” is intended to mean a securing mechanism that includes one or more rods mechanically linking two or more securement members, such that actuation of a single positioning lever causes simultaneous motion of multiple securement members.

In the present invention, the term “cam-configured securing mechanism” is intended to mean a securing mechanism in which a rotatable cam element converts rotational input into linear extension or retraction of a securement member.

In the present invention, the term “retracted position” is intended to mean a position in which the securement member is drawn inward such that it does not extend beyond the lateral edge of the panel and does not interfere with insertion or removal of the panel.

In the present invention, the term “extended position” is intended to mean a position in which the securement member projects laterally from the edge of the panel to engage or press against the interior surface of the window frame.

In the present invention, the term “adjustment slot and pin mechanism” is intended to mean a mechanical arrangement in which a guide pin travels within a shaped slot to define a predetermined movement path—typically diagonal or curvilinear—of a movable component, such as a latch or securement member.

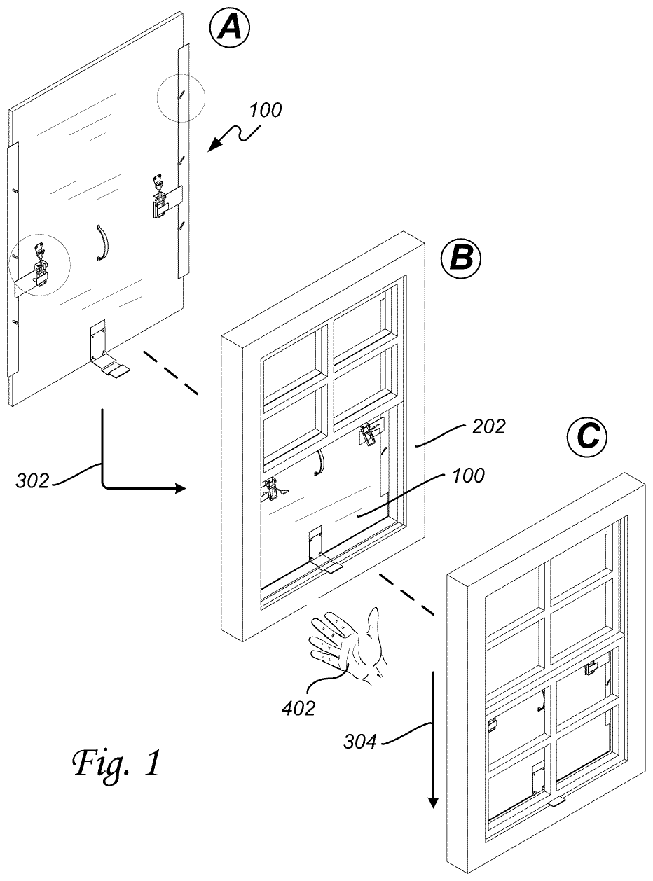

Turning now to the drawings in greater detail, it will be seen that FIG. 1 illustrates one example of installing an interior-mount protective window covering system 100 configured for tool-less installation from within a building. In an exemplary embodiment, the protective window covering system 100 is shown in the process of being positioned within a window 202, where the window defines a frame having opposing vertical side jambs, an upper lintel, and a lower sill. The protective window covering system 100 comprises a panel 102, which is configured to be received substantially within the inner perimeter of the window frame, inserted from the interior-facing side of the structure. This configuration enables a user to install or remove the system without accessing the exterior of the building and without the use of permanent brackets, fasteners, or specialized tools.

The interior-mount configuration is particularly advantageous in environments where exterior access is impractical, hazardous, or prohibited. For example, occupants of multi-story residential buildings, elderly individuals, or those with limited mobility can deploy the system entirely from within the safety of the building. Likewise, during adverse weather events or emergency scenarios, the ability to install the system quickly and without exterior exposure enhances both safety and responsiveness. Unlike traditional exterior storm shutters, which require exterior ladder access, or magnet-mounted films and panels that rely on surface adhesion, the present invention secures a rigid panel 102 through mechanical engagement with the interior structure of the window frame itself. As such, the system provides a repeatable and structurally integrated protective solution that can be deployed proactively or reactively, depending on conditions.

The panel 102 may be temporarily or semi-permanently seated within the frame, depending on user preference, and can be removed or reinstalled without damaging the underlying window structure. This tool-less, non-invasive installation strategy broadens the applicability of the system across a wide range of building types and use cases, including rented units, commercial storefronts, and legacy structures where permanent alterations are undesirable or restricted by code or lease agreements. The panel 102 may be rectangular or shaped to correspond to the interior perimeter of the window 202 and is sized to provide a close-fitting engagement when inserted flush with the inner faces of the frame. The system includes a handle 104 connected to a lower portion of the panel 102, which allows a user 402 to hold and maneuver the panel through the open portion of the window 202. The handle 104 is accessible to the user 402 while the window remains partially or fully open, enabling installation without exterior access or the use of tools.

In this embodiment, the securement members 108 are positioned along opposing lateral edges of the panel 102. These securement members 108 are configured to extend outwardly, laterally beyond the panel's sides, such that they press against the interior surfaces of the window frame to retain the panel 102 in place. The securement members are each mounted to a corresponding adjustment mechanism that allows controlled extension and retraction. Although not directly visible in this figure, the securement members are linked to securing mechanisms that may include latch systems, rods, cams, or tube-driven actuators, each capable of translating user 402 input into multi-directional mechanical displacement.

The motion arrows 302 in the figure indicate the direction of movement during installation, which is inward from the user's 402 side and aligned with the plane of the window opening. Once the panel 102 is properly positioned within the frame, the securement members 108 are extended outward to engage the left and right frame surfaces of the window 202, thereby resisting dislodgement in response to wind pressure or external impact forces. This side-loading engagement provides structural support without relying on exterior mounting brackets or screws, which are often required in prior approaches.

The closed sash motion 304 of the window 202 is also shown in this figure. Once the panel 102 is in place and the securement members 108 are extended, the window 202 can be closed to abut or engage the rear surface of the panel. This adds an additional axis of constraint, particularly along the vertical plane, and can prevent vertical slippage or inward tilting of the panel under load. The inclusion of the window sash as a passive locking interface demonstrates how the invention integrates into the natural architecture of the window assembly without modification.

The spatial relationship between the panel 102, handle 104, securement members 108, and window components 202 highlights a key differentiator of the present invention: it is designed to be deployed entirely from within the building, using only the interior opening of the window and without the need for external access, tools, or permanent hardware. This interior-mount configuration enables safer and more accessible installation, particularly in multi-story buildings, during adverse weather, or for users 402 with limited mobility.

Furthermore, the use of side-engaging securement members 108 avoids reliance on compression against the glazing surface, reducing the risk of breakage or distortion. The controlled mechanical extension of these securement members provides a repeatable, removable solution not seen in fixed-size boards or ad-hoc coverings. Unlike prior approaches that rely on external clips, suction cups, or gravity-based engagement, the present system uses positive lateral locking to ensure a secure, load-bearing interface distributed across multiple contact points within the frame.

In an exemplary embodiment, the protective window covering system 100 is installed and secured using a tool-less, interior-facing method that accommodates users without requiring modification to the window frame 202. The user 402 initially positions the panel 102 within the window frame 202 from inside the building structure, inserting it laterally or vertically through an open sash of the window. The panel 102 is dimensioned to fit substantially within the boundaries of the frame defined by the sill, lintel, and opposing vertical jambs. Once in position, the user actuates one or more securing mechanisms 126—such as levers, latches, cams, or rods—to transition the associated securement members 108 from a retracted position, wherein the members are flush with or retracted into the lateral sides of the panel 102, to an extended position, wherein the securement members 108 protrude outwardly and contact the left and right interior surfaces of the window frame 202. This engagement establishes lateral compression that holds the panel 102 securely within the frame. After the securement members 108 are extended, the user closes the window sash, which contacts a threshold clamp 122 positioned along the bottom edge of the panel 102. The act of closing the window sash applies passive downward force against the threshold clamp 122, enhancing the vertical retention of the panel 102 and stabilizing the assembly without the need for tools, adhesives, or permanent fasteners. This method provides an intuitive and non-destructive installation workflow that allows easy deployment, securement, and removal of the protective window covering system 100.

The illustrated configuration in FIG. 1 establishes the basic installation method that is common to each variation of the invention. Regardless of the securing mechanism used, the system is anchored laterally within the frame by opposing securement members and vertically constrained by the window sash, if closed. This multi-axis restraint strategy promotes both safety and performance, ensuring that the panel remains secured even under fluctuating wind loads or accidental interior contact.

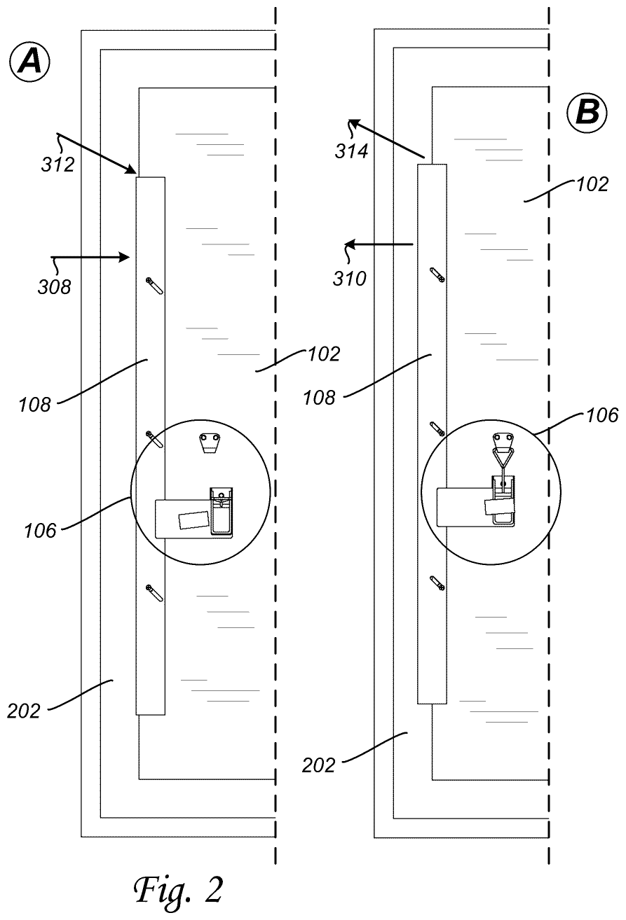

Referring to FIG. 2, there is illustrated one example of the dynamic positioning of a securement member 108 between a retracted position 308 (reference ‘A’) and an extended position 310 (reference ‘B’) during the operation of the interior-mount protective window covering system 100. In an exemplary embodiment, the panel 102 is shown with a pair of securement members 108, each mounted along opposing lateral edges of the panel. These securement members 108 are mechanically linked to a securing mechanism, not shown in this figure, that controls their position along a diagonally offset path defined by an adjustment slot and a guide pin interface.

As shown in the portion labeled reference ‘A’, each securement member 108 is in a retracted state 308, closely nested along the lateral edge of the panel 102. In this configuration, the width of the system 100 is minimized, enabling the user to insert the panel 102 into the interior-facing side of the window frame 202. The motion 312 to reach this retracted position is governed by the interaction between a fixed guide pin 116 and a diagonal adjustment slot 114, which is formed integrally within the body of each securement member 108. The guide pin 116 is anchored to a structural portion of the panel 102 and does not move relative to the panel body during actuation.

As the user 402 transitions the system to a secured state, the securing mechanism is actuated, causing the securement members 108 to shift diagonally outward 314 along the panel's plane. This diagonal path 314 is shown in reference ‘B’, where each securement member 108 has translated along the sloped axis of the adjustment slot 114 to achieve an extended position. The motion 310 of the securement member is constrained and guided by the fixed guide pin 116, which forces the slot to slide along a defined trajectory. Importantly, the diagonal orientation of the adjustment slot 114 provides a dual-axis displacement—simultaneously moving the securement member 108 outward 310 (laterally) and slightly upward 314 (vertically) relative to the panel 102. This configuration ensures that the securement member presses against the interior vertical surfaces of the window frame and downward on the windowsill for three points of contact, while also providing minor wedging or bracing action along the vertical dimension, improving contact stability under load.

The diagonally guided extension achieved through the interaction of a fixed guide pin 116 and a sloped adjustment slot 114 provides a mechanically deterministic and spatially constrained method of deploying the securement member 108. This configuration ensures that movement occurs along a predictable path that combines lateral 308/310 and vertical 312/314 displacement, thereby enhancing the stability and bracing force of the panel 102 within the window frame. The use of a fixed guide pin 116 eliminates floating tolerances and reduces potential motion variability, while the diagonal orientation of the adjustment slot 114 introduces a natural wedging effect against the interior frame surfaces. This arrangement promotes firm engagement without over-reliance on material deformation or spring loading and significantly reduces mechanical backlash or drift during repeated use. As a result, the panel remains reliably positioned with a consistent locking force, contributing to a secure, tool-free installation and removal experience.

Moreover, the dual-position visualization in FIG. 2 anticipates dynamic use scenarios where the system may need to be partially extended, quickly disengaged, or repositioned without full removal. For example, in emergency egress scenarios or after a storm event, the user can retract the securement members via the same slot-guided mechanism and remove the panel without using tools, unscrewing hardware, or exposing the interior to exterior elements.

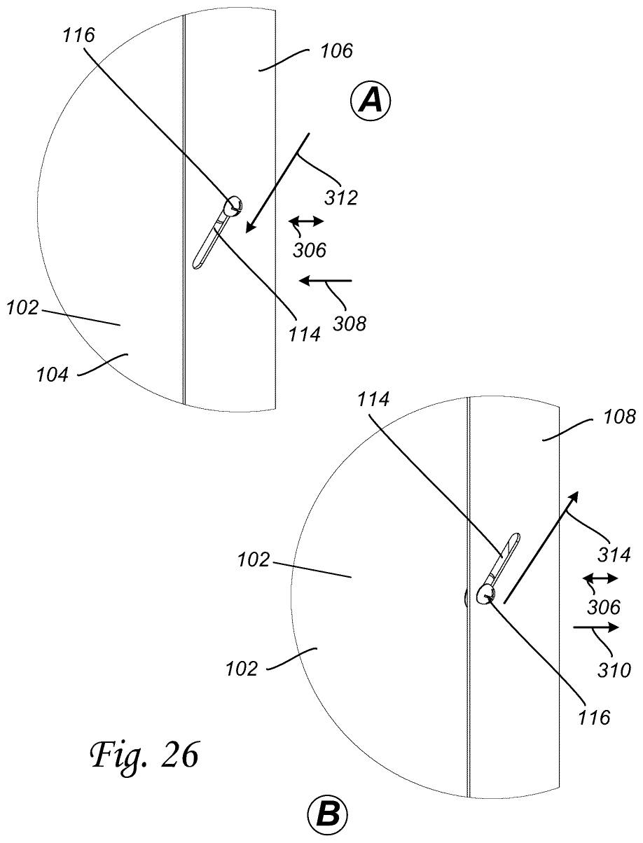

The method of movement seen here is further detailed in FIG. 26, which provides a magnified view of the adjustment slot 114, guide pin 116, and motion vectors 308/312 (retracted) and 310/314 (extended). Together, FIGS. 2 and 26 define the structural and operational basis of a mechanically constrained securement system that provides reliable retention under pressure, ease of retraction, and consistent engagement—all from the interior side of the structure.

The spatial arrangement illustrated in FIG. 2 reinforces one of the core novelties of the invention: a tool-less, mechanically-actuated, interior-mount protective window covering system that uses guide-slot mechanisms to establish precise, non-compressible, laterally-braced contact between the panel and the window frame. This avoids reliance on frictional or adhesive engagement methods used in prior approaches and enables rapid, repeatable deployment even in constrained or adverse-use environments.

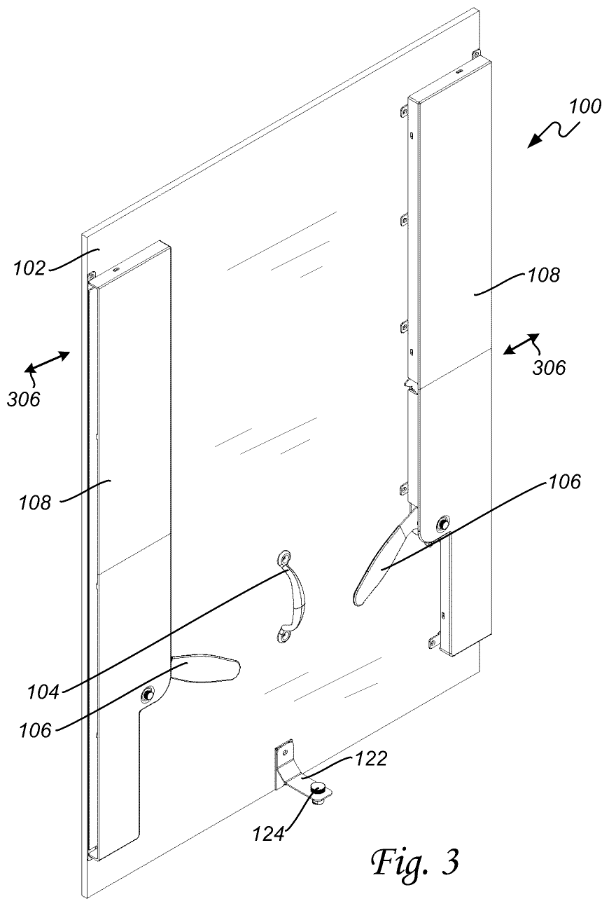

Referring to FIG. 3-6, there is illustrated one example of a protective window covering 100 having a cam configured securing mechanism 126. In an exemplary embodiment, FIG. 3 illustrates a back-side perspective view of an interior-mount protective window covering system 100 featuring a cam-configured securing mechanism 126. In an exemplary embodiment, the panel 102 is oriented such that its rear-facing surface—i.e., the surface facing the building interior during installation—is visible. Along each lateral edge of the panel 102, securement members 108 are positioned and are operably coupled to respective cam-configured securing mechanisms 126 assemblies, which comprise positioning levers 106 that are operationally connected to the cam-configured securing mechanism 126. These position levers are disposed adjacent to or partially recessed within the thickness of the securement members 108, and they are rotationally mounted to the securing member 108 or panel 102. The positioning levers 106 extend outwardly and are pivotally connected to each cam-comfigured securing mechanism 126, allowing user 402 to apply manual torque to actuate the cam rotation.

Each cam-configured securing mechanism 126 assembly is configured such that rotational motion of the lever 106 results in lateral displacement 306 of the securement member 108, driving it outward from the side of the panel 102 toward the interior edge of the frame of the window 202 or retracting it inward toward the panel 102 from the frame of the window 202. Importantly, the cam-configured securing mechanisms 126 are mounted in a location slightly offset from the central vertical axis of the panel 102, with one assembly on the left lateral edge and one on the right lateral edge. The mirror symmetry of this placement allows coordinated engagement on both sides of the panel 102, promoting uniform bracing within the frame of the window 202. The backside perspective in FIG. 3 also reveals the integration of the handle 104, located near the bottom half of the panel 102, and the threshold clamp 122, which extends horizontally and is secured to the bottom edge of the panel 102. Together, these components facilitate both the placement and anchoring of the panel 102 from the building's interior side.

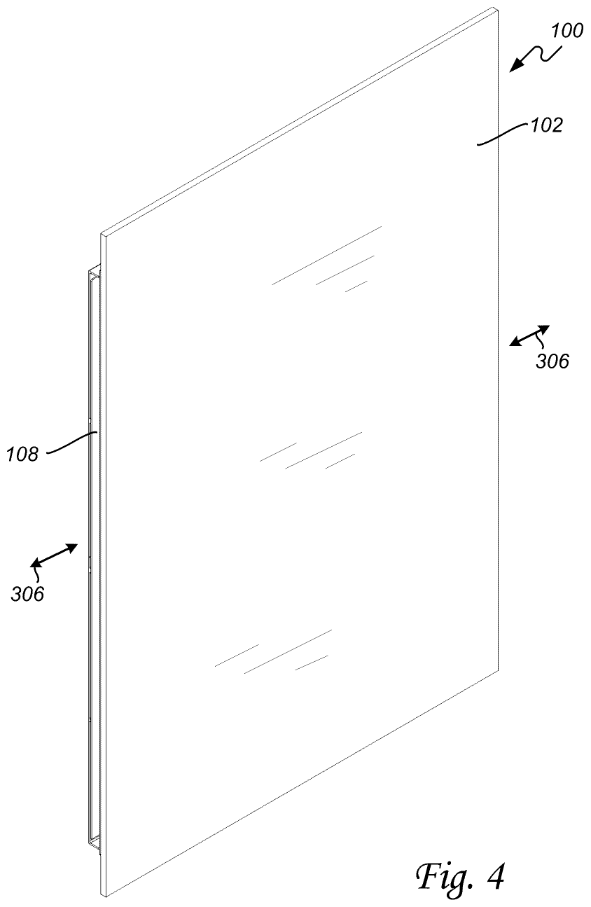

Referring to FIG. 4, there is illustrated a front-side perspective view of the protective window covering system 100 featuring the same cam-based securing mechanism 126. In this exemplary embodiment, the outward-facing side of the panel 102—the side oriented toward the window glass during normal installation—is visible. While the front surface appears smooth and unobstructed, the securement members 108 extend laterally beyond the side edges of the panel in their deployed position. The placement of the cams-configured securing mechanism 126 and levers 106 behind the panel 102 ensures that no components protrude forward toward the windowpane. This flush or recessed front surface prevents interference with the glass and maintains a visually unobtrusive profile when viewed from the exterior.

From this perspective, the symmetrical lateral deployment of the securement members 108 can be appreciated, as each extends outward from a position just behind the front surface of the panel. The panel's vertical height and width are configured to match the interior perimeter of the window frame, while the securement members 108 are dimensioned to bridge any residual gap between the panel edges and the window frame walls when actuated. The front view confirms that all actuation mechanisms remain fully accessible from the rear (interior) side of the structure, preserving the system's tool-less, interior-mount characteristics.

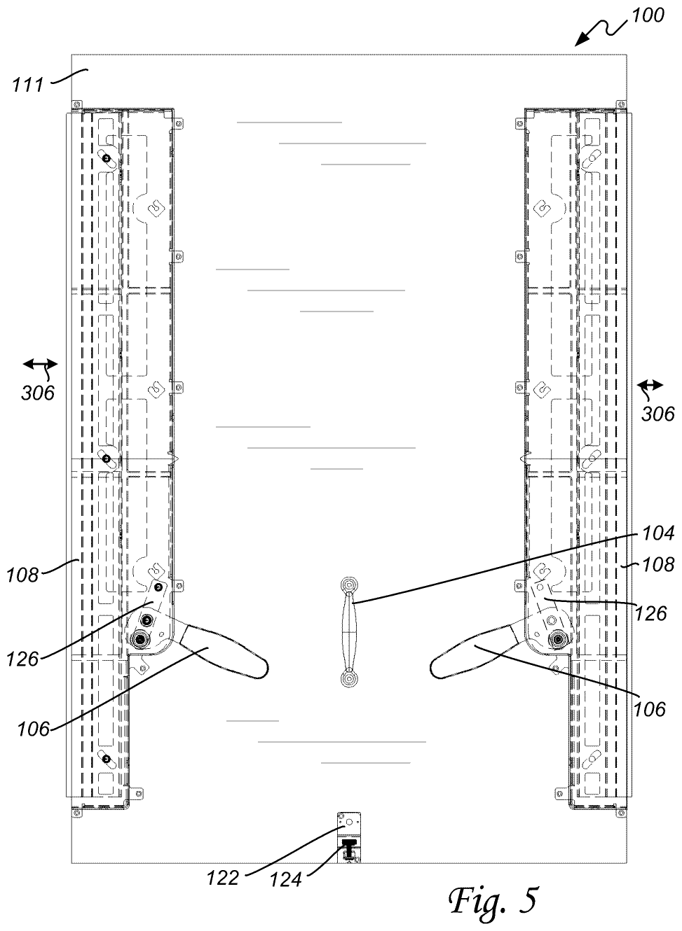

Referring to FIG. 5, there is illustrated a rear elevation view of the protective window covering system 100, with dashed hidden lines to depict internal features of the cam-actuated securing mechanism 126. In this exemplary embodiment, the panel 102 is shown from the rear, with both left and right securement members 108 visible. Within each securement member 108, the cam-configured securing mechanism 126 bodies are partially illustrated as hidden line features, indicating their location inside the securement members 108. Each cam-configured securing mechanism 126 is rotationally anchored to the panel 102 via a mounting point and mechanically linked to a positioning lever 106.

The positioning levers 106 extend diagonally toward the center of the panel, indicating a rotational axis that lies inward and slightly rearward relative to the securement members 108. The securement members are laterally movable with respect to the body of the panel 102 and may be guided by an internal slot or track, not visible in this figure but shown in related views. Also visible is the threshold clamp 122 centrally positioned along the lower horizontal edge of the panel, connected to a fastener 124 that anchors the threshold clamp 122 to the bottom sill of the window 202 frame during use. The back-side view with internal features reinforces the mechanical pathway between manual actuation of the lever 106, rotation of the cam-configured securing mechanism 126, and outward movement of the securement member 108.

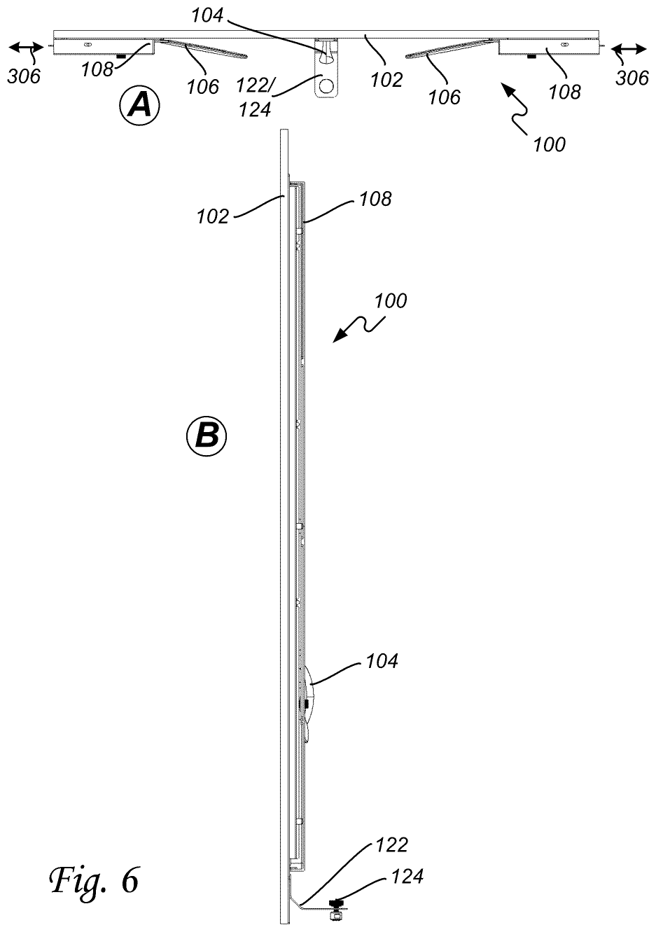

Referring to FIG. 6, there is illustrated a top view (reference A) and a right-side view (reference B) of the protective window covering system 100 with the cam-configured securing mechanism 126. In the top view (A), the spatial relationship between panel 102 and the lateral securement members 108 is evident. Each securement member 108 can be extended beyond the side edge of the panel 102 in a direction perpendicular to the panel's vertical axis. The cam-configured securing mechanism 126 are shown mounted within the inner boundary of the securement members 108, and the positioning levers 106 are attached to the cams in an orientation that permits rotation in a plane parallel to the panel's rear surface.

In the right-side view (B), the vertical stacking of key components is revealed. The securement member 108 sits just behind the panel 102, and the can-configured securing mechanism 126 is offset rearward of the panel's center plane, allowing the lever 106 to rotate freely without obstruction. The threshold clamp 122 is positioned beneath panel 102, extending slightly forward to engage the interior sill of the window 202. The spatial configuration shown in this view illustrates how the entire actuation assembly—including the cam-configures securing mechanism 126, positioning lever 106, and securement member 108—is housed fully within the interior side of the system, preventing interference with the window 202 glass or exterior wall surface.

This dual-view representation further demonstrates that actuation of the positioning lever 106 results in outward translation of the securement member 108 without linear sliding components or external hardware. The eccentric geometry of the cam converts rotational input into a lateral pushing force, generating sufficient bracing pressure against the frame interior to secure the panel under load.

In operation, the cam-actuated securing mechanism 126 embodiment shown in FIGS. 3 through 6 provides a structurally integrated and mechanically deterministic solution for achieving lateral bracing of the protective panel 102 within a window 202 frame. This embodiment leverages rotational input through a user-operated positioning lever 106 to produce lateral translation of the securement members 108. Each securement member 108 is directly driven by a rigid mechanical linkage to a cam-configured securing mechanism 126, which is pivotally anchored to the panel 102 in a spatial position aligned behind the panel's rear surface and inwardly from its lateral edges.

When the positioning lever 106 is rotated from a rest position to an engaged position, the non-concentric geometry of the cam-configured securing mechanism 126 causes the securement member 108 to move laterally outward along the plane of the frame of the window 202. The magnitude of this displacement is governed by the cam's offset and radius of rotation, allowing a designer to calibrate the engagement force and range of movement without increasing system complexity. The cam-configured securing mechanism 126 can be fabricated from metal or high-strength polymer and may be molded or machined to achieve precise profiles. The positioning levers 106 can be rotatably attached via pin joints, press fits, or integrated bosses, depending on manufacturing and durability requirements.

Because the motion path is generated by rotational eccentricity rather than sliding or compressive motion, the system avoids component binding or frictional losses common in sliding rail designs. Furthermore, because each securement member is actuated by a discrete cam-lever assembly, the user can independently control the engagement force on each side of the panel 102, allowing for adaptive installation in frames that may be non-parallel, uneven, or out-of-square. This adjustability is a key differentiator over static-fit panels and provides a higher degree of user control in varied deployment environments.

The spatial configuration of the cam-configured securing mechanism 126 components is intentionally rearward of the panel 102 and does not extend forward beyond the panel's front face. This allows the panel to sit flush against the interior surface of the window glazing or sash without interference. By housing the cams and levers on the rear side of the system, the invention preserves a low visual profile from the exterior and minimizes intrusion into the living space.

The cam-configured securing mechanism 126 embodiment is further enhanced by the integration of a threshold clamp 122, which anchors the bottom edge of the panel 102 against the windowsill or sash, and may include a fastener 124 for additional stability. In use, once the securement members 108 have been extended laterally into contact with the vertical sides of the window frame, the user can close the window 202 to compress the threshold clamp 122 in place, creating a multi-point, three-dimensional locking interface that resists dislodgment under wind load or impact.

In operation, the cam-configured securing mechanism 126 embodiment demonstrates the practical and patentable implementation of a tool-less, interior-deployable window protection system using a rotational actuation mode. It provides a repeatable, mechanically reliable means of securing a panel within a window frame while preserving accessibility, safety, and ease of deployment—all without requiring external access, adhesive materials, or permanent structural alteration.

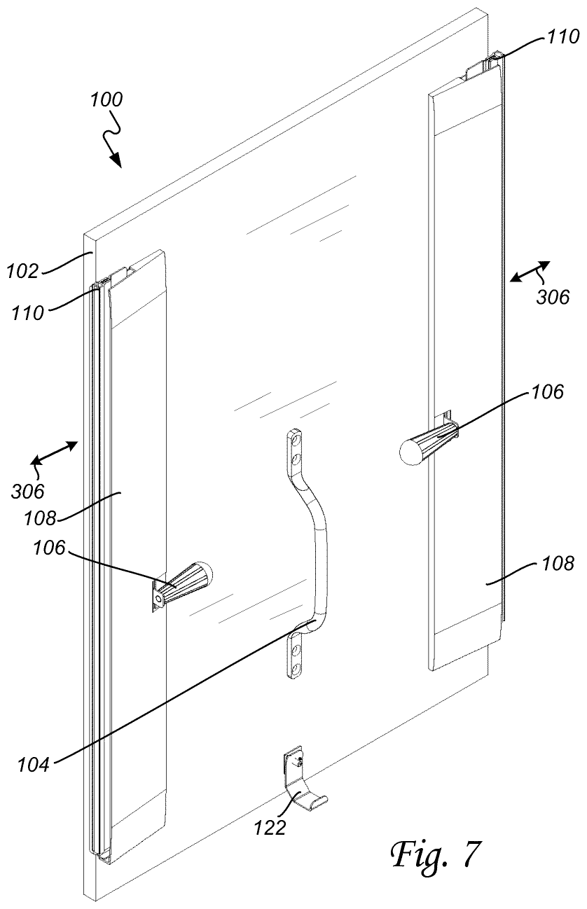

Referring to FIGS. 7-10, there is illustrated one example of a protective window covering having a rotatable or pivotable lever (repositionable lever) configured securing mechanism. In an exemplary embodiment, FIG. 7 illustrates a rear perspective view of a protective window covering system 100 that includes a repositionable-lever securing mechanism 126. In this exemplary embodiment, the panel 102 is shown oriented for interior-facing installation into a window frame 202, with a separate repositionable lever 106 mounted along each of the opposing lateral sides of the panel. Each lever 106 is exposed on the rear-facing surface of the panel 102 and is independently accessible to a user during installation. The levers 106 are rotationally and/or pivotally mounted to the panel and are each operatively connected to a corresponding securement member 108 positioned adjacent to their respective lateral edge. In operation, each lever translates user-applied rotational input into lateral displacement of its associated securement member, allowing the securement members to be extended or retracted independently to brace the panel within the window frame.

The lever 106 can be configured to be rotated inward toward the panel face to move 306 the securement member 108 laterally outward (motion 310) for engagement with the interior vertical side of the window frame, and rotated outward from the panel to retract the securement member (motion 308) for removal or repositioning. The mechanical coupling between the lever and securement member may include a direct link, rack-and-pinion, or threaded shaft, though these details may vary across implementations. Also shown is a threshold clamp 122 that can be contoured to match the bottom edge of the window. The threshold clamp 122 extends along the bottom edge of the panel 102 and is bent slightly inward, with a geometry designed to abut the windowsill when the panel is fully seated.

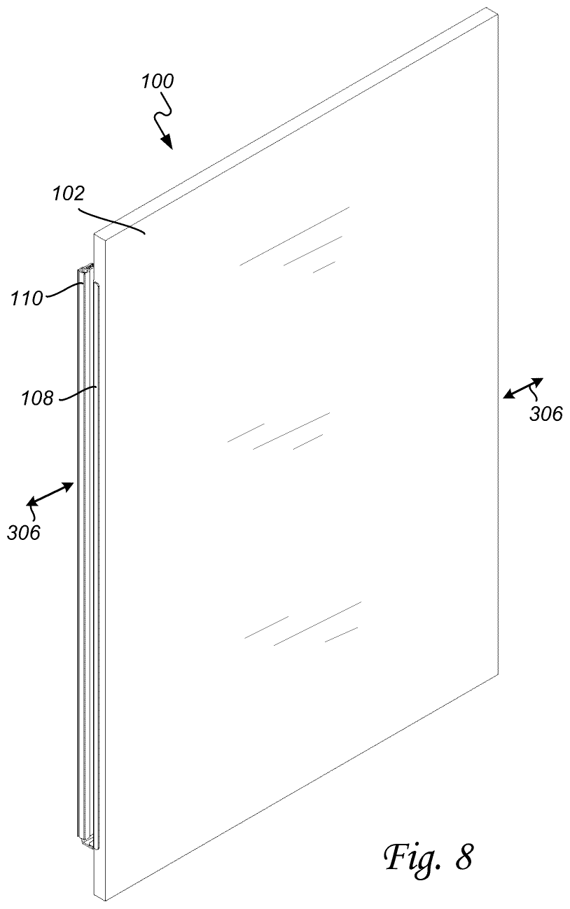

Referring to FIG. 8, there is illustrated a front-side perspective view of the protective window covering system 100 utilizing the repositionable-lever securing mechanism 126. In this exemplary embodiment, the panel 102 is viewed from the front-facing side—the side that faces outward after installation. From this angle, the lever 106 and other actuation components are not visible, confirming that the mechanism remains entirely on the rear and lateral sides of the panel.

Importantly, the securement members 108 can be seen projecting laterally outward from the opposing left and right sides of the panel 102. Each securement member is slidably mounted within the panel and mechanically linked to a corresponding repositionable lever 106 on the rear side, which enables user-controlled actuation. Upon rotation of the levers, the securement members are translated outward into an extended position, pressing firmly against the interior vertical surfaces of the window frame 202 to stabilize and retain the panel.

Along the window-contacting edge of each securement member, a seal 110 is affixed. This seal may be formed from a compliant, resilient material such as rubber, closed-cell foam, or a weather-resistant elastomer. The seal 110 serves multiple critical functions: it enhances the frictional grip between the securement member and the window frame, provides a buffer to accommodate small dimensional irregularities in the frame, and establishes a weather-resistant interface that can reduce air and water infiltration around the mounted panel. The presence of the seal allows the securement members to engage with the frame without marring its surface or relying solely on hard-edge contact.

The panel 102, as viewed from the front-facing side in this figure, maintains a smooth and unobtrusive appearance. None of the actuation components or securement mechanics protrude into the room space, preserving the aesthetic and functional integration of the system.

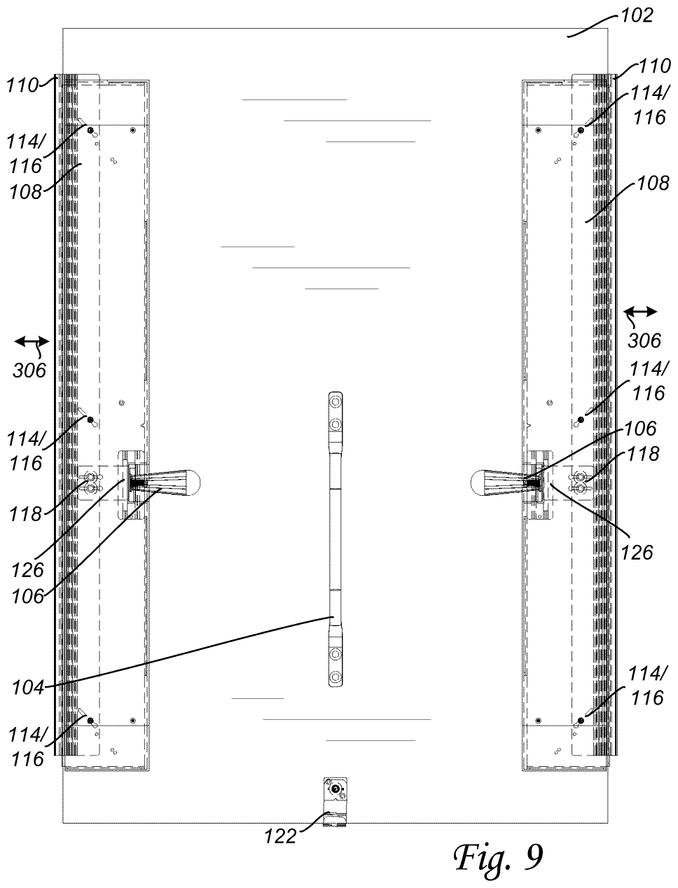

Referring to FIG. 9, there is illustrated a rear elevation view of the protective window covering system 100, with hidden lines provided to depict the internal components of the repositionable-lever securing mechanism 126. In this exemplary embodiment, the securement members 108 are shown laterally extended from opposing vertical sides of the panel 102. Hidden line features within the panel reveal internal linkages that translate rotational input from the levers 106 into lateral movement of the securement members.

Each repositionable lever 106 is operatively linked to a corresponding securement member 108 through a mechanical transmission system, which can include a threaded actuator, a pivot linkage, or a sliding rod assembly. As the user rotates or pivots the lever, the connected securement member undergoes a controlled motion along a guided path 306, transitioning between a retracted position via path 308 and an extended position via path 310. These movements are spatially constrained by internal guide structures within the panel 102, ensuring alignment, repeatability, and structural consistency during installation or removal.

To enhance engagement with the window frame 202, a seal 110 is disposed along the window-contacting surface of each securement member 108. The seal is configured to compress slightly against the vertical frame surfaces when the securement member is extended, creating a resilient interface that dampens vibration, improves weather resistance, and distributes contact pressure to reduce wear or surface marking. This resilient sealing feature also compensates for minor frame irregularities or misalignments, further improving performance across diverse window geometries.

The threshold clamp 122 appears slightly angled or bent to conform to the upper profile of the windowsill, allowing for passive engagement when the window is closed. This configuration enhances downward stability without relying on fasteners or protrusions, preserving the non-invasive and tool-less nature of the system.

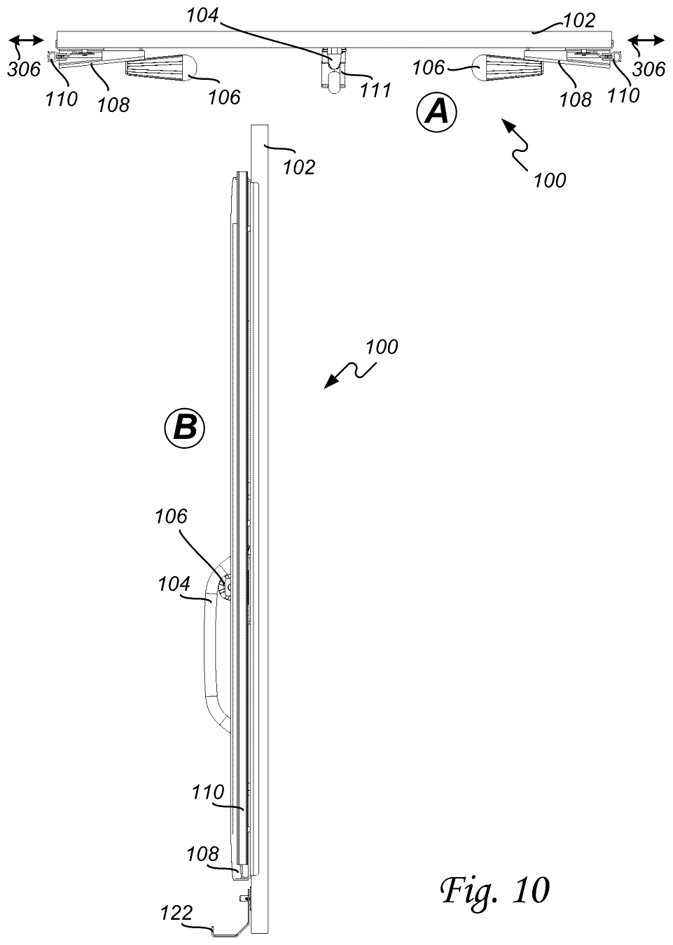

Referring to FIG. 10, there is illustrated both a top view (reference A) and a left-side view (reference B) of the protective window covering system 100, highlighting the spatial relationships of the components in the repositionable-lever securing mechanism 126 configuration.

In the top view (A), the securement members 108 are clearly shown extending outward from lateral slots in the panel 102, with their inner ends coupled to internal linkages controlled by the rear-mounted levers 106. These components remain enclosed or recessed during retraction, helping avoid interference with window trim or interior features. The securement members 108 extend laterally along an axis perpendicular to the panel face, ensuring direct and even engagement with the opposing window 202 frame walls.

In the left-side view (B), the securement member 108 is shown in alignment with the lateral edge of the panel 102, extending outward in its deployed position to engage the vertical surface of the window frame 202. The repositionable lever 106 is positioned on the rear-facing surface of the panel and protrudes outward slightly, but remains within a compact and ergonomic envelope, allowing manual actuation from inside the building without impeding sash movement or interior clearance.

The handle 104 is also visible in this view, mounted to the lower region of the panel 102. It is strategically located to be accessible through the open portion of the window 202, enabling the user to grasp and guide the panel into position during installation. This placement facilitates precise control of the panel's vertical and lateral movement while ensuring the handle remains entirely within the interior space and does not interfere with the window sash when closed.

Also visible is the threshold clamp 122, extending slightly from the lower edge of the panel. The clamp is formed with an intentional upward bend that conforms to the sill geometry. When the window sash is closed, it passively compresses the clamp against the sill surface, creating a frictional engagement that improves vertical stability of the installed panel. This self-seating configuration eliminates the need for additional fasteners or adhesives, reinforcing the system's tool-less, non-destructive installation methodology and preserving the integrity of both the window and surrounding structure.

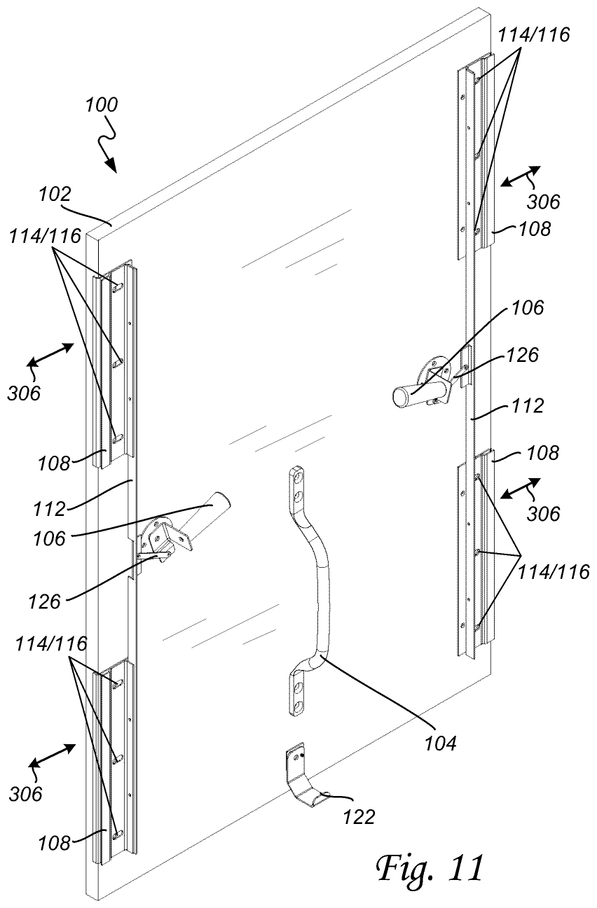

Referring to FIGS. 11-14, there is illustrated one example of a protective window covering having a rod configured securing mechanism. FIG. 11 illustrates a rear perspective view of a protective window covering system 100 incorporating dual rod securing mechanisms 126. In this exemplary embodiment, the panel 102 is oriented for interior-facing installation within a window frame 202. The rear side of the panel 102 reveals two positioning levers 106—one disposed proximate the left side and the other proximate the right side of the panel 102. Each positioning lever 106 is independently mounted and associated with its own rod securing mechanism 126.

Each rod securing mechanism 126 includes a vertically oriented rod 112 extending the vertical length of the panel 102 from the rod securing mechanism 126 along each of the lateral sides of the panel 102. Each of these rods 112 are operatively linked to at least two securement members 108, spaced apart along the corresponding left or right edge of the panel 102. Actuation of a given lever 106 causes synchronized extension or retraction of the associated securement members 108 along that side. This independent mechanism configuration enables the user 402 to fine-tune lateral positioning and frame engagement on each side of the panel individually, offering a self-correcting advantage over prior approaches that relied on symmetrical or linked mechanisms, which could bind or misalign under imperfect conditions.

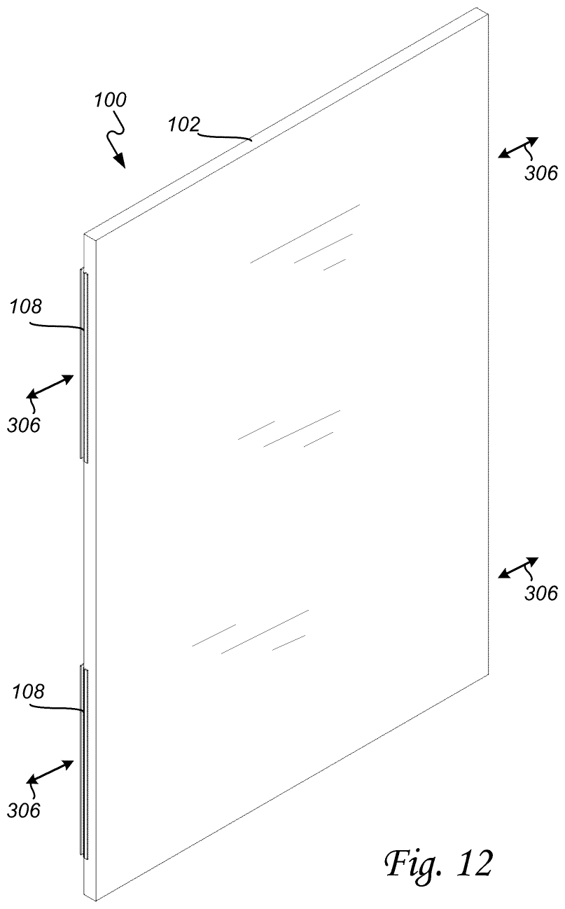

FIG. 12 illustrates a front perspective view of the same system 100. The panel 102 presents a smooth and aesthetically neutral front-facing surface, with no protruding mechanical components visible. The securement members 108 are shown in their extended state, protruding laterally to engage the vertical inner surfaces of the window frame 202. Because the rod securing mechanisms 126, rods 112, and positioning levers 106 are all located on the rear side of the panel.

A handle 104 is integrally formed along the lower interior-facing portion of the panel 102. Its spatial positioning allows the user to grasp the panel from inside the structure through an open window, enabling ergonomic placement and removal of the system without exterior access. This combination of concealed mechanisms and user-facing handle contributes to the clean, non-obtrusive installation that defines the invention's tool-less, interior-mount approach.

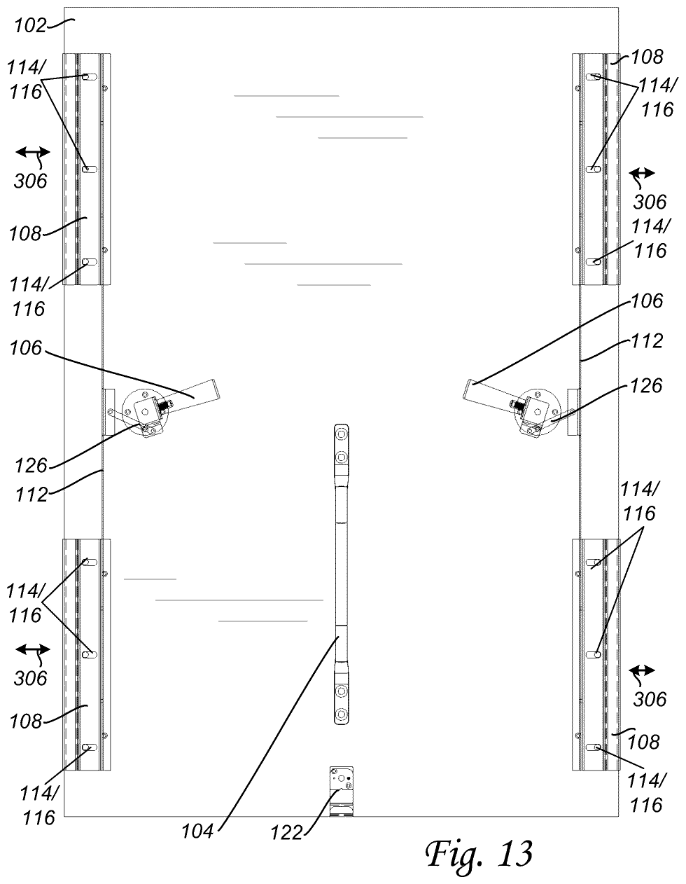

Turning to FIG. 13, a rear elevation view with hidden lines reveals the internal layout of the dual rod securing mechanisms 126. Each positioning lever 106 is operatively connected to a corresponding rod 112, which extends along the vertical length of the panel 102 and interfaces with multiple securement members. These connections may include pivot joints, sliding collars, rack-and-pinion, or other suitable configurations that convert lever 106 motion into linear translation of the securement members 108.

The left-side and right-side rod securing mechanisms 126 are structurally distinct and functionally independent, each comprising its own positioning lever 106, rod 112, and set of securement members 108. Actuation of the left-side lever 106 results exclusively in the extension or retraction of the left-side securement members 108, while actuation of the right-side lever 106 affects only the right-side securement members 108. This dual-mechanism configuration enables side-specific control, facilitating precise lateral engagement and panel alignment even when the window frame exhibits dimensional irregularities or asymmetries. The architecture supports independent sealing force on each side, enhancing contact integrity and installation flexibility without relying on uniform or mirrored mechanical motion across the panel.

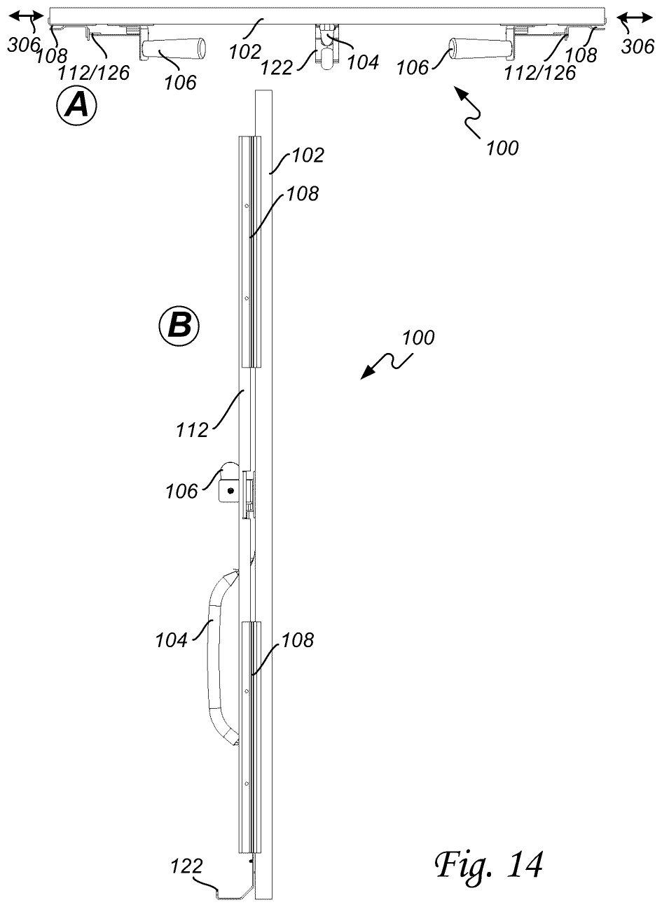

In FIG. 14, reference view ‘A’ provides a top-down look at the system 100. The extended securement members 108 on both lateral edges are visible, projecting perpendicularly from the panel 102. The rods 112 are contained within or adjacent to the side walls of the panel, linking the upper and lower securement members on each side.

The positioning levers 106 are visible along the upper rear surface, one near each lateral corner, confirming the dual independent configuration.

Reference view ‘B’ illustrates a left-side perspective of the system. The securement members 108 are shown in their extended position, mechanically linked by a laterally oriented rod 112. The handle 104 is visible along the lower portion of the panel's interior-facing surface, projecting slightly to facilitate user 402 access during installation or removal. Notably, all actuation and adjustment components—including the rod securing mechanism 126—are confined within the rear profile or internal volume of the panel 102. This spatial arrangement supports a fully interior-mount installation, eliminating the need for exterior access, drilling, adhesives, or modification of the window sash or frame.

In an exemplary embodiment, the protective window covering system 100 employs a rod-based securing mechanism 126 configured for simultaneous actuation of multiple securement members 108 on each lateral side of the panel 102. During use, the user 402 positions the panel 102 into the window frame 202 from the interior-facing side of the structure, using the handle 104 located along the lower portion of the panel 102 to guide it through an open window sash. The panel 102 is dimensioned to nest within the window frame 202 with minimal clearance along the left and right interior jambs. Once positioned, the user engages a positioning lever 106 located near each lateral side of the rear panel surface. Each positioning lever 106 is operably coupled to a rod 112 housed within the panel body. As the lever 106 is rotated or pivoted, the rod 112 translates along a defined guide path, simultaneously driving a pair of securement members 108 into extended positions at both the upper and lower regions of the same side of the panel. This paired deployment ensures uniform pressure against the interior side surfaces of the window frame 202, improving mechanical retention without requiring user fine-tuning.

Concurrent with this actuation, a threshold clamp 122, integrally mounted along the lower rear edge of the panel 102, is positioned to contact and conform to the contour of the windowsill. The clamp 122 may include a bend or curvature and can passively engage with the sill upon placement. When the window sash is subsequently closed over the installed panel 102, downward pressure from the sash secures the threshold clamp 122 in place, creating a tool-less vertical retention force that supplements the lateral engagement of the securement members 108. This method allows for a fast, ergonomic, and secure installation of the protective panel 102 from inside the building, without the need for drilling, adhesives, or external access.

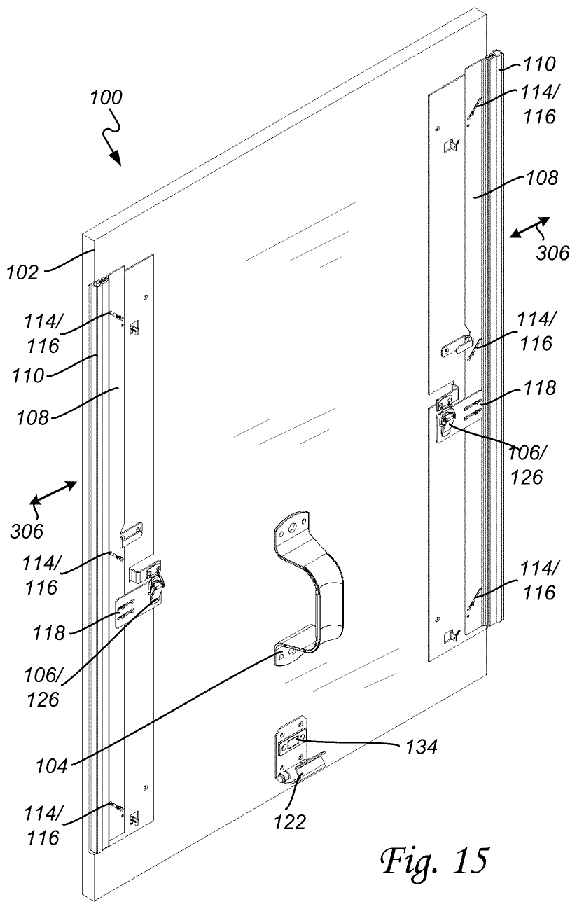

Referring to FIGS. 15-18, there is illustrated one example of a protective window covering having a latch configured securing mechanism. FIG. 15 illustrates a backside perspective view of the protective window covering system 100 employing a latch securing mechanism 126. In this exemplary embodiment, the panel 102 is configured for interior-facing installation and is shown oriented for insertion into a window frame 202. Each lateral side of the panel 102 includes an independently operable latch securing mechanism 126, comprising a manually actuated latch that functions as a positioning lever 106. These positioning levers 106 are disposed near the upper portion of the rear surface of the panel 102 and are pivotally connected to respective latch hook assemblies positioned beneath corresponding protective covers.

Each positioning lever 106 is mechanically coupled to at least one securement member 108 on the same lateral side. The securement members 108 are shown partially extended, protruding laterally from the left and right vertical edges of the panel 102. These members are guided by internal hardware and translate between retracted and extended positions through latch rotation. The extension is constrained and supported by an integrated frame adjust 118, which allows each securement member 108 to be fine-tuned in its resting position relative to the frame of the window 202. This ensures that when the securement members 108 are retracted, the panel 102 can be easily inserted or removed, and when extended, a firm and gap-minimizing engagement with the window frame 202 is achieved.

Also visible is the seal 110, which is mounted along the window-facing edge of each securement member 108. This seal provides a combination of frictional engagement, cushioning, and weather resistance once the securement members 108 are fully extended and pressed against the frame.

At the lower edge of panel 102, the threshold clamp 122 is shown in a deployed position. This clamp is hinged at its mid-point and can rotate downward to rest against the interior-facing windowsill and upward for storage. A magnetic coupler 134 is affixed to the panel 102 to retain the threshold clamp 122 in a stowed, upward-folded position during transport or non-use. The threshold clamp 122 enables non-permanent yet effective vertical anchoring without adhesives, screws, or tools.

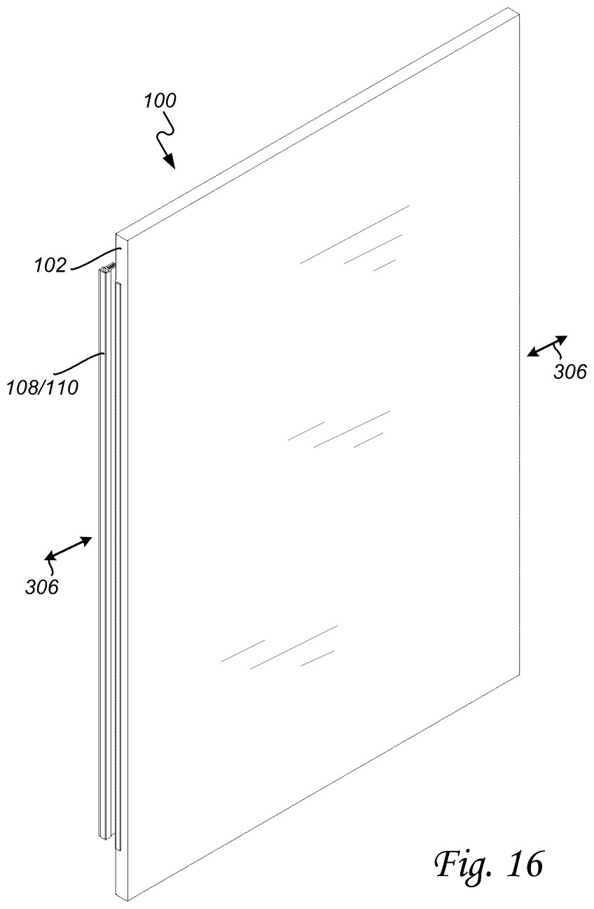

Referring to FIG. 16, there is illustrated a front-side perspective view of the protective window covering system 100 employing the latch securing mechanism 126. From this view, the panel 102 occupies a substantial portion of the window opening and presents a clean, unobstructed face toward the room interior. The securement members 108 are not visibly protruding from this angle, indicating that the forward-facing geometry of the system is kept compact and flush.

A portion of the seal 110 can be observed seated along the lateral boundaries of the panel, illustrating how it would press against the inner surface of the window frame 202 when the securement members 108 are fully deployed. This embodiment prioritizes visual minimalism and spatial efficiency.

Although the threshold clamp 122 is not clearly visible from this angle, its concealment affirms the low-profile and passive nature of its integration. The clamp's configuration remains compliant with the overarching goal of tool-less, reversible, and damage-free installation.

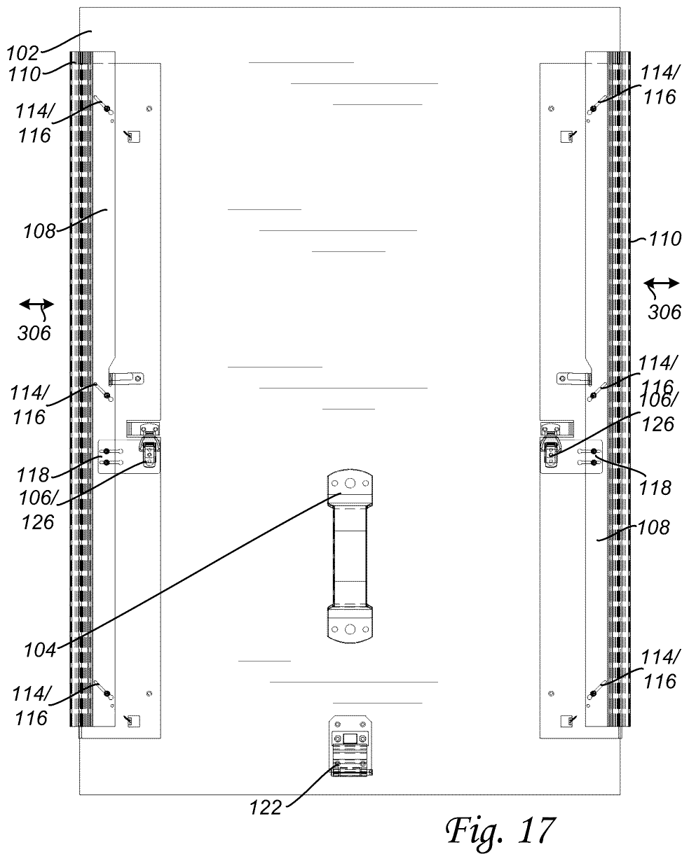

Referring to FIG. 17, a rear elevation view of panel 102 is shown with dashed hidden lines illustrating the internal layout of the latch securing mechanism 126. Both the left and right sides of the panel feature discrete latch 106 mechanisms, each linked via internal mechanical assemblies to respective securement members 108.

The frame adjust 118 is more clearly depicted in this view. It comprises a housing or track feature into which the securement member 108 nests, enabling minor positional adjustments before actuation. This not only helps accommodate slight dimensional variations in different window frames but also ensures a repeatable and secure engagement upon each use.

The magnetic coupler 134 is seen positioned along the lower rear surface of the panel 102, aligned to receive and retain the threshold clamp 122 in its upward-stowed configuration. When released, the threshold clamp 122 pivots downward via its hinge and rests against the windowsill, further aiding in vertical stability and resisting inward tilting or displacement of the panel 102 during window closure.

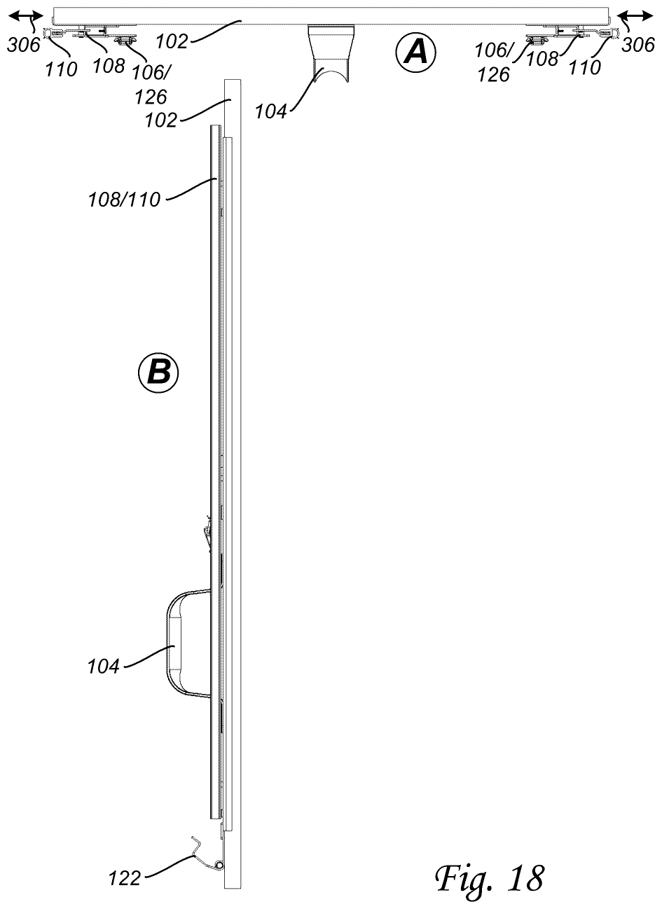

Referring to FIG. 18, a two-part view is provided. In reference ‘A’, a top view of panel 102 is shown, where the left and right securement members 108/seal 110 extend slightly beyond the lateral edges of the panel, illustrating their deployed state.

Each securement member 108 is operatively linked to a corresponding latch 106 positioned near the top corners of the panel. The panel 102 is dimensioned to fit snugly within the window frame 202, and the symmetric configuration of the securing system allows either or both lateral sides to be independently actuated depending on the installation conditions.

In reference ‘B’, a left-side view is shown, highlighting the securement member 108 extending laterally from the panel, with the seal 110 affixed along its window-facing edge to ensure compliant, weather-resistant engagement with the interior surface of the window frame. The threshold clamp 122 is also visible in this view, shown in an intermediate position between its lowered, operative orientation and its stowed, upright position. The threshold clamp 122 is contoured to conform to the interior geometry of a typical windowsill, allowing it to nest passively along the sill surface. When the window sash is closed, the clamp is pressed downward against the sill, creating a secure, tool-less anchoring mechanism that does not require screws, adhesives, or supplemental fasteners.

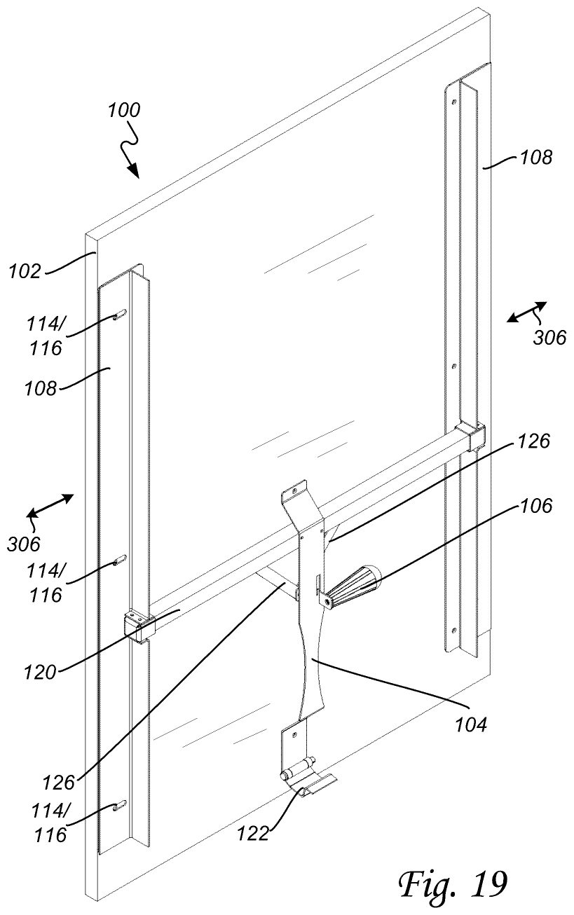

Referring to FIGS. 19-22, there is illustrated one example of a protective window covering system 100 incorporating a tube securing mechanism 126. In this exemplary embodiment, the tube securing mechanism 126 utilizes an internally spring-loaded architecture to extend and retract the securement members 108 positioned along opposing lateral sides of the panel 102. The configuration shown across FIGS. 19-22 integrates a mechanical linkage between the positioning lever 106, a tube 120 structure housing a spring 128 and plunger 130 assembly, and a pair of securement members 108, all mounted internally or rearwardly to the panel 102 for a flush, interior-mount configuration.

Turning first to FIG. 19, a backside perspective view is presented. Panel 102 is shown oriented for interior-facing installation into a window frame 202, and includes a handle 104 located along the lower interior-facing edge of the panel. The handle 104 serves both as a user 402 grasp point for positioning and removing the panel 102, and as a mechanical mounting anchor for the tube securing mechanism 126. The positioning lever 106 is shown integrated with the handle 104 structure, and is operatively connected to an internal spring 128 and plunger 130 system housed within a horizontally oriented tube 120 that traverses the width of the panel 102 behind or within its lower region. Securement members 108 are coupled to the distal ends of the plunger 130 within the tube and extend laterally outward from both sides of the panel.

The left and right securement members 108 are mechanically linked to the internal spring-loaded plungers 130 such that, in the default state, the springs 128 bias the plungers 130 and securement members 108 outward toward the lateral interior frame surfaces of the window 202. In this view, the outer ends of the tube are capped with endcaps 132, which serve as terminal abutment points for the plungers and may also mechanically interface with the securement members 108 to transmit extension or retraction forces. The overall layout ensures that actuation via the lever 106 causes the plunger 130 to overcome the spring bias and retract the securement members 108 inward, enabling installation or removal of the panel.

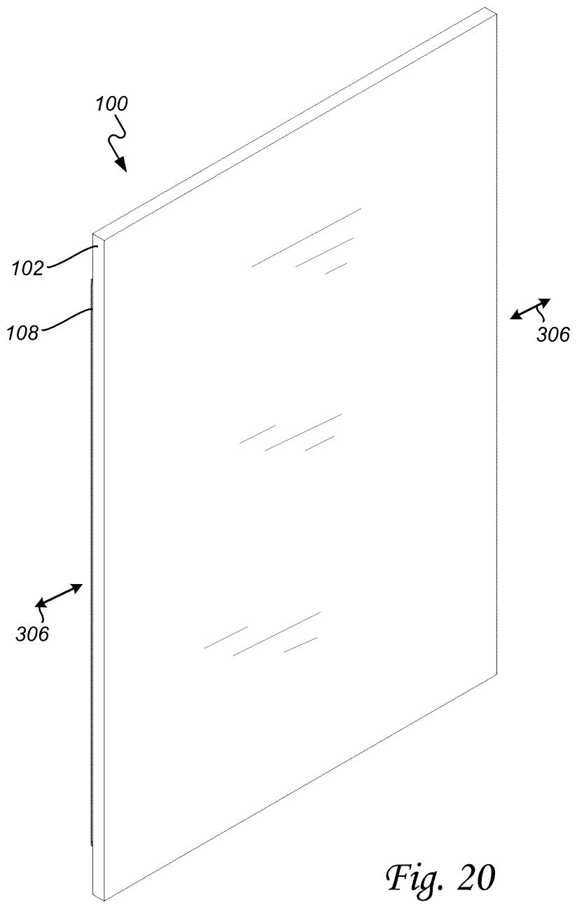

Moving to FIG. 20, a front perspective view is provided. Panel 102 appears smooth and unencumbered from the front, emphasizing the system's non-intrusive appearance and compatibility with conventional window aesthetics. The securement members 108 are positioned on the left and right lateral edges of the panel. Because all functional components, including the tube securing mechanism 126 and positioning lever 106, are mounted to the rear side or embedded within the panel 102, the front face remains clean and low-profile—avoiding interference with light entry or sash closure.

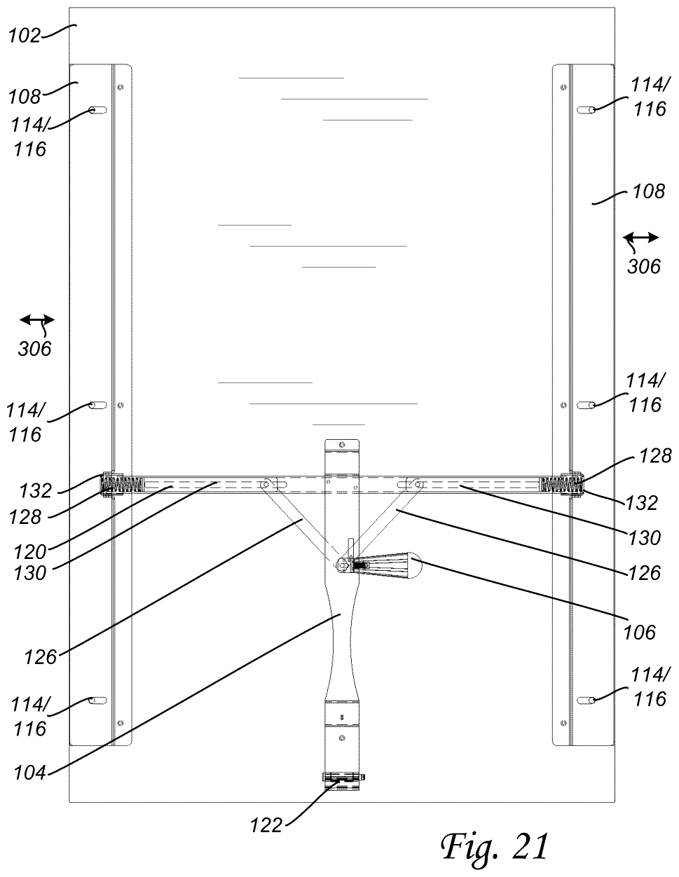

In FIG. 21, a rear elevation view with hidden lines reveals the internal structure of the tube securing mechanism 126. A horizontally oriented tube extends across the lower interior-facing portion of the panel 102 and houses a pair of opposing springs 128 and corresponding plungers 130, each situated on opposite sides within the tube. Each plunger 130 is mechanically linked—either directly or through rod extensions—to a respective securement member 108, enabling coordinated lateral motion. The handle 104 and positioning lever 106 are centrally located along the bottom edge of the panel and serve as the primary user interface. When user 402 actuates the lever 106, the motion simultaneously compresses or releases both springs 128, driving the plungers 130 inward or outward. This, in turn, causes the securement members 108 to retract or extend 306 in a symmetrical and mechanically balanced manner, facilitating tool-less engagement with or disengagement from the window frame 202.

The endcaps 132 at both ends of the tube define physical bounds for plunger motion and ensure proper directional alignment during extension and retraction cycles. These endcaps may also serve as bearing or guide structures to maintain coaxial plunger movement and consistent lateral force distribution across the securement members 108.

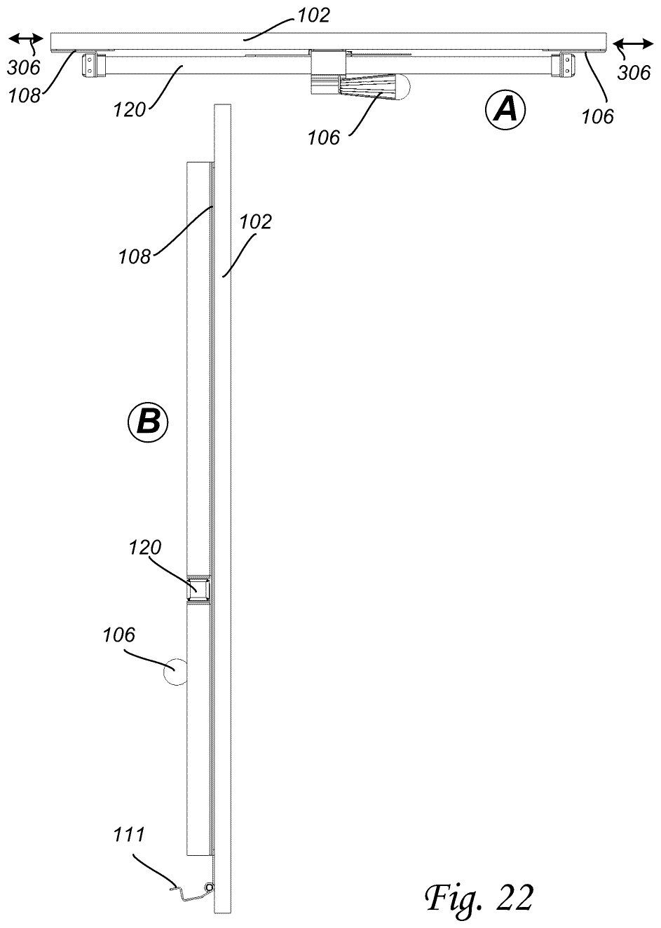

Turning to FIG. 22, reference view ‘A’ presents a top view, while reference view ‘B’ offers a left-side view. In view ‘A’, the tube securing mechanism 126 is centrally positioned across the lower rear edge of the panel 102. The securement members 108 can extend laterally beyond the panel perimeter, and their outward displacement is driven by the spring-loaded plunger system housed in the tube 120. The endcaps 132 are visible from above and appear flush with the panel edge, preserving a compact installation profile.

In view ‘B’, the left securement member 108 is visible, projecting laterally to engage the window frame 202. The handle 104 is seen projecting slightly from the lower rear portion of the panel 102, positioned for easy access by the user 402. The threshold clamp 122 is also illustrated in its downward operative position and is configured to rest against the window sill. The clamp may optionally include a magnetic coupler 134 (not shown in this embodiment) or a hinged joint for upward stowing during storage. In this orientation, the clamp contributes to vertical retention without requiring permanent fasteners or damaging the existing window structure.

In an exemplary embodiment, the protective window covering system 100 incorporates a tube securing mechanism 126 housed along the lower interior-facing region of the panel 102. This mechanism includes a centrally located positioning lever 106 integrated into the handle 104, which serves both as a user gripping point and as a structural mounting interface for the internal actuation system. Internally, the tube securing mechanism 126 contains a horizontally aligned tube extending laterally across the panel, within which opposing springs 128 and plungers 130 are positioned. Each plunger 130 is mechanically linked to a corresponding securement member 108 via rod extensions or coupling assemblies.

During installation, the user 402 positions the panel 102 from within the structure by grasping the handle 104 and guiding the panel 102 into the window frame 202 through the open sash. The panel is dimensioned to fit flush between the interior vertical jamb surfaces of the window frame. Once in place, the user releases the positioning lever 106, allowing the preloaded springs 128 to automatically drive the plungers 130 outward. This spring bias forces the securement members 108 to extend laterally beyond the left and right sides of the panel 102, pressing them into firm engagement with the vertical interior surfaces of the window frame 202. This passive deployment eliminates the need for active lever manipulation or manual alignment and ensures symmetrical, balanced force distribution across both sides of the panel.

The user then lowers the threshold clamp 122, which is coupled near the bottom of the panel 102, into contact with the interior windowsill. The clamp 122 may be formed with a contoured geometry that passively mates with the sill surface. Once the panel is positioned and the threshold clamp 122 is in contact with the sill, the window sash is closed. This closing action compresses the threshold clamp 122 against the sill and secures the extended securement members 108 between the panel 102 and the window frame 202, locking the panel in place. The method provides a rapid, tool-less installation process that leverages spring force for securement while maintaining full interior accessibility.

In operation, the tube securing mechanism 126 provides a self-contained, spring-actuated deployment method that reduces the number of moving external components, simplifies user actuation through a single lever 106, and ensures equalized pressure across both sides of the panel. This architecture supports reliable tool-less installation, conformal sealing, and repeatable securement without reliance on external brackets, drilling, or adhesives—addressing limitations in prior approaches.

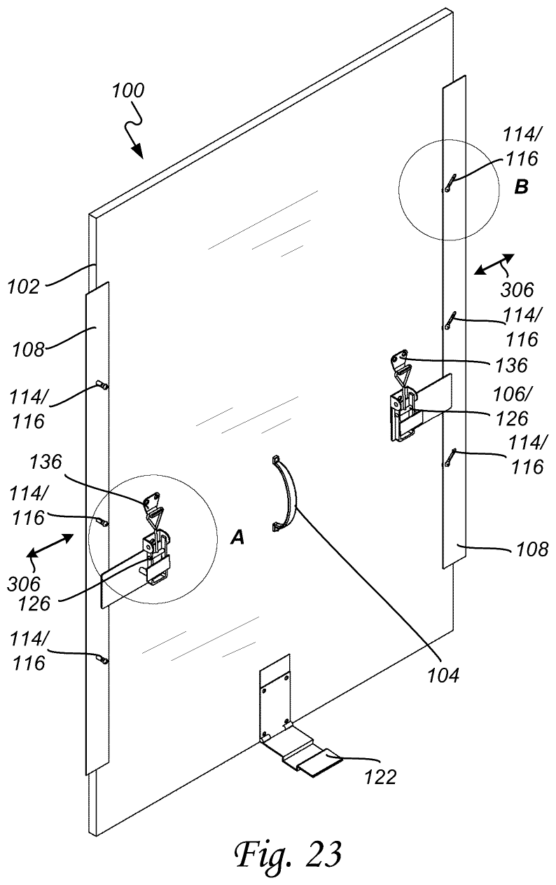

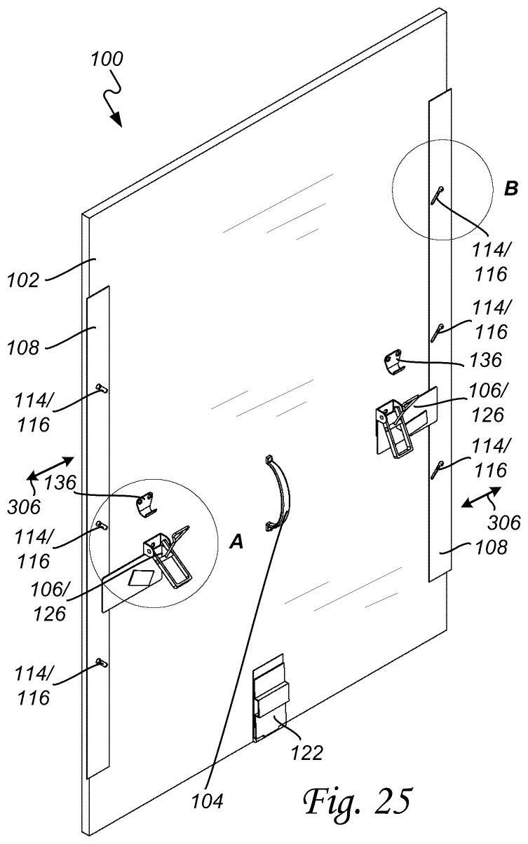

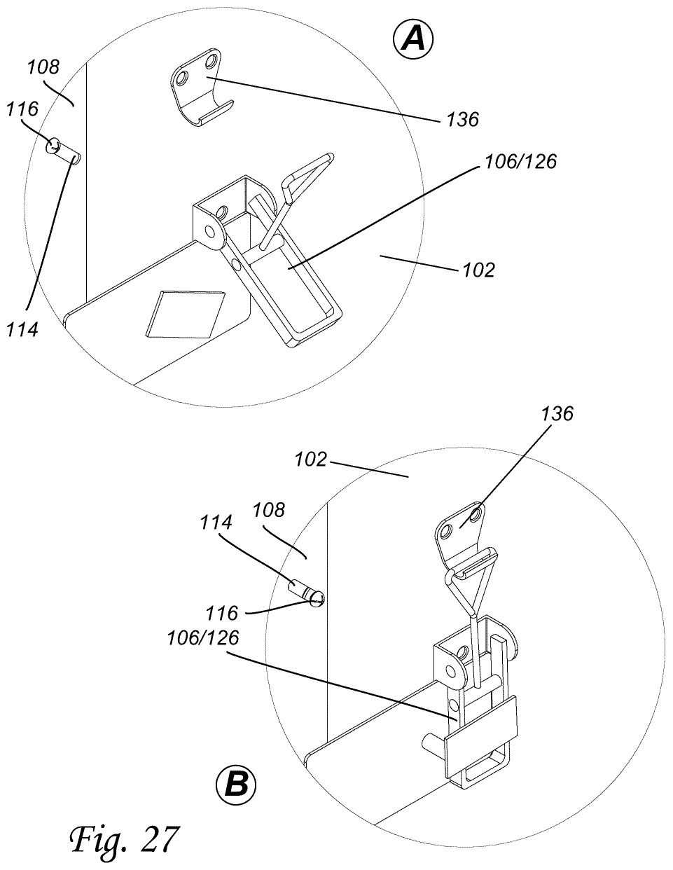

Referring to FIGS. 23-25, there is illustrated an exemplary embodiment of the protective window covering system 100 is illustrated, employing a latch securing mechanism 126. In this embodiment, reference label ‘A’ in FIGS. 23 and 25 denotes an enlarged area further detailed in FIG. 27, while reference label ‘B’ corresponds to an enlarged area shown in FIG. 26.

In FIG. 23, the system is shown in a backside perspective view, with the latch mechanism 126 in a closed position. Two opposing latches 106 are mounted near the lower corners of the panel 102, each operatively coupled to a corresponding securement member 108. These latch-configured securing mechanisms 126/106 are slideable and, when slid to the extended position, align with the latch ring 136 for locking, driving the securement members 108 laterally outward from the left and right sides of the panel 102. When unlocked, they can be slid to the retracted position, drawing the securing members 108 inward, allowing the position or removal of the panel 102 from the window 202. The lock ring 136 can be fastened to the panel 102.

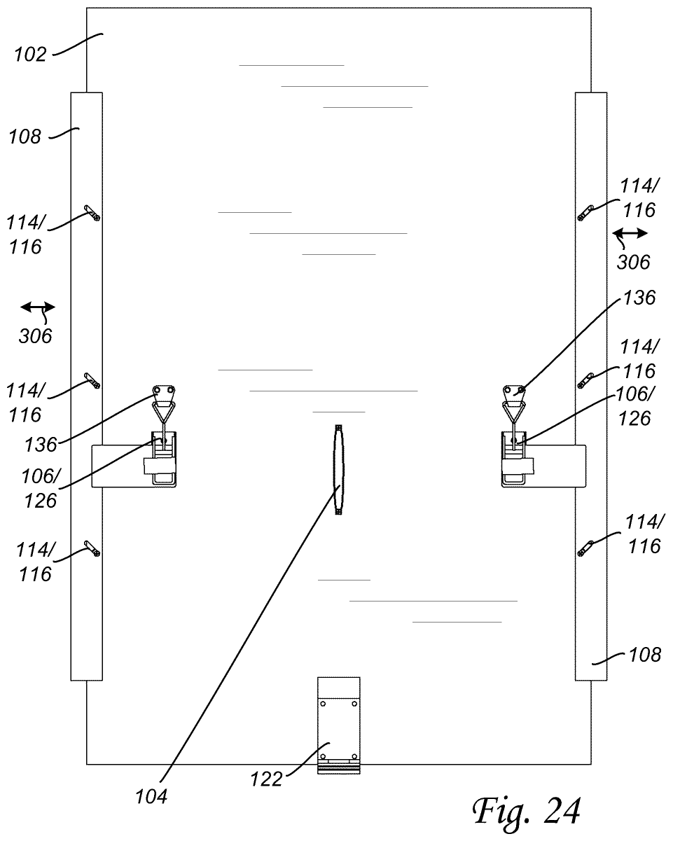

FIG. 24 presents a rear elevation view of the protective window covering system 100, illustrating the symmetric arrangement of the latch securing mechanisms 126 along both lateral sides of the panel 102. The securement members 108 are shown in their extended positions, protruding laterally from the left and right edges of the panel to interface with the interior frame of the window 202. Each latch 106 is independently operable and mechanically linked to its respective securement member 108, allowing the user 402 to actuate one side of the system without affecting the other. This independent actuation enables the system to adapt to frame irregularities, such as slight angular deviations or asymmetries, ensuring secure engagement on both sides. Mounted adjacent to each latch 106 is a latch ring 136, which serves as a locking interface when the latch 106 is slid into the extended position. These rings 136 can also be repositioned on the panel 102 to accommodate variations in window 202 width, contributing to the system's adaptability across a wide range of installation conditions.

FIG. 25 illustrates a backside perspective view of the protective window covering system 100 with the latch securing mechanisms 126 shown in the open or disengaged position. In this view, each latch 106 is slid away from its respective latch ring 136, causing the connected securement members 108 to retract inward toward the central body of the panel 102. This retracted state allows the panel to be inserted into or removed from the window frame 202 without interference or binding along the lateral frame surfaces. The latch components 106 remain mechanically coupled to the securement members 108 through internal sliding linkages, which are housed within the rear region of the panel 102 and oriented for movement along a substantially horizontal axis. The symmetry between the left-side and right-side latch mechanisms is preserved, and because each latch 106 functions independently, user 402 can operate them one at a time during installation or removal. The handle 104 is also visible at the lower center of the panel, extending slightly outward and providing an intuitive grasping point for the user during repositioning operations. The threshold clamp 122 can be observed in its passive, downward position beneath the lower edge of the panel, and is shaped to interface frictionally with the interior sill surface of the window 202 once the sash is closed. This embodiment emphasizes quick, tool-less deployment and removal, supported by clear mechanical states—extended for engagement, retracted for disengagement—visually confirmed through the position of the latches 106 relative to the latch rings 136.

Referring now to FIG. 26, there is illustrated an exemplary close-up view of the motion of a securement member 108 guided along an adjustment slot 114. The adjustment slot 114 is defined as a diagonal or slanted channel formed in either the panel 102 or the securement member 108, depending on the configuration. A guide pin 116 is secured in fixed position relative to the panel 102 and inserted through the slot 114 to constrain the path of travel of the securement member 108. In this embodiment, the slot 114 is located in the securement member 108 and oriented diagonally downward and outward from the panel centerline, while the guide pin 116 is fixed into a channel or boss within the panel 102 body.

Reference ‘A’ in the figure shows the securement member 108 undergoing retraction motion inward 308 and downward diagonal 312, where the guide pin 116 remains stationary and the slot 114 slides over it, drawing the securement member inward toward the central body of the panel. Reference ‘B’ shows the securement member 108 in its extended position, with the same slotted motion 310 enabling a diagonally outward 314 translation relative to the panel 102. This angled displacement not only enables lateral engagement with the frame of the window 202 but also imparts a slight vertical component to the motion, promoting a wedging or binding effect against the interior vertical frame surfaces. For disclosure purposes, such extending and retracting motion can be referred to as motion 306.

The diagonally-guided path of travel defined by the angled slot 114 and fixed guide pin 116 establishes a mechanically deterministic motion profile for the securement member 108. This precision-guided interaction produces consistent extension and retraction behavior along a defined axis, minimizing backlash and maintaining stable positional retention with minimal user effort. The transmission path between the slot 114 and pin 116 operates independently of deformable components, spring tension, or subjective user input, resulting in a robust and repeatable deployment mechanism. This structural interface also enhances overall safety, alignment, and usability for tool-less installations. Additionally, the slot-and-pin system is compatible with various actuation modalities—including lever-driven, rod-linked, cam-actuated, and latch-based configurations—without requiring modification to the core mechanical guidance geometry, thereby supporting platform flexibility while preserving functionality.

In an exemplary embodiment, each securement member 108 can be constrained within a plurality of adjustment slots 114, which also function as guide slots defining a deterministic path of travel. The adjustment slots 114 can be integrally formed in the panel 102 and govern the controlled motion of the securement member 108 between its retracted and extended positions. This constrained path ensures precise lateral displacement and minimizes mechanical drift or rotational misalignment during operation. In certain embodiments, the adjustment slot 114 interfaces with a guide pin 116 or similar feature to translate user-applied force into predictable mechanical output. The adjustment slot 114 thus serves as both a mechanical guide and an adjustment interface, promoting reliable engagement with the window frame 202 while enabling tool-less actuation. This dual functionality supports consistent alignment, reduced user effort, and improved system robustness across varying installation conditions.

Referring now to FIG. 27, there is illustrated one example of a latch-configured securing mechanism 126 in both retracted and extended states. The figure presents two perspective views, with reference view ‘A’ depicting the latch 106 in an open or retracted position, and reference view ‘B’ showing the latch 106 in a closed or extended position. In both views, the latch-configures securing mechanism 126 is slideably mounted to the securement member 108, and the latch ring 136 is secured to panel 102.

In view ‘A’, the latch-configured securing mechanism 126 is unlatched and can be translated inward, withdrawing the associated securement member 108 into the body of the panel 102. This retracted position allows the panel 102 to be placed into or removed from a window frame 202 without interference from the securement member 108. The interface between the latch-configured securing mechanism 126 and the panel 102 includes molded or formed rails that constrain movement along a linear path and prevent rotational displacement. The latch ring 136 is spaced from the latch-securing mechanism 126 in this state, disengaged from its locking interface.

In view ‘B’, the latch-securing mechanism 126 has been pushed or slid outward into the closed or extended position. In this configuration, the latch-configured securing mechanism 126 engages with the latch ring 136, which is fixed to the rear surface of the panel 102. The latch ring 136 acts as a mechanical stop and retention interface that locks the latch-securing mechanism 126 into position, thereby maintaining the securement member 108 in its fully extended state. The securement member 108 projects laterally beyond the edge of the panel 102 to contact the vertical inner surfaces of the window frame 202. This deployment exerts lateral holding force sufficient to secure the panel without screws, adhesives, or tools.

This latch-configured securing mechanism 126 enables reliable, manual actuation by the user 402 from the interior of the building and can be manufactured using minimal parts while offering consistent performance.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

1. An interior-mount protective window covering system configured for tool-less installation from within a building, the interior-mount protective window covering system comprising:
a panel configured for insertion into a window frame from an interior-facing side of a structure;
a plurality of securement members slidably mounted along lateral sides of the panel, each of the plurality of securement members being extendable from a retracted position to an extended position to press against the window frame;
at least one securing mechanism operatively coupled to each of the plurality of securement members and configured to translate user input into extension and retraction of each of the plurality of securement members; and
a handle disposed on the panel and accessible to a user for inserting, removing, or adjusting the position of the panel within the window frame.

2. The interior-mount protective window covering system of claim 1, further comprising:
a threshold clamp coupled to a bottom portion of the panel and configured to be positioned along a windowsill.

3. The interior-mount protective window covering system of claim 1, wherein the securing mechanism comprises a latch assembly including a hook and loop configured to lock the securement member in an extended position.

4. The interior-mount protective window covering system of claim 1, wherein the securing mechanism comprises a cam assembly configured to rotate about an eccentric axis to actuate the securement member.

5. The interior-mount protective window covering system of claim 1, wherein the securing mechanism comprises a rotatable lever or pivotable lever coupled to a threaded or linked extension member.

6. The interior-mount protective window covering system of claim 1, wherein at least one securement member comprises a seal along a window-contacting edge to provide a weather-resistant barrier.

7. The interior-mount protective window covering system of claim 1, wherein each securement member is guided by at least one adjustment slot formed in the panel and a guide pin secured within the adjustment slot.

8. The interior-mount protective window covering system of claim 7, wherein the guide pin is fixed relative to the panel, the adjustment slot is formed in the securement member and positioned at a diagonal angle, and the adjustment slot is configured to move relative to the guide pin as the securement member transitions between retracted and extended positions.

9. A method of using the interior-mount protective window covering system of claim 1, the method comprising:
positioning the panel into the window frame from an interior-facing side of the structure;
extending the plurality of securement members from retracted positions to extended positions by actuating the at least one securing mechanism, thereby
pressing each of the plurality of securement members against lateral interior surfaces of the window frame; and
closing the window to retain the panel in place.

10. An interior-mount protective window covering system configured for tool-less installation from within a building, the interior-mount protective window covering system comprising:
a panel configured to fit within a window frame from an interior-facing side of a structure;
a plurality of securement members positioned on opposing lateral sides of the panel;
a pair of rods, each rod operatively linking at least two securement members on a common side of the panel; and
a positioning lever coupled to at least one of the rods and configured to actuate movement of the linked securement members between a retracted position and an extended position.

11. The interior-mount protective window covering system of claim 10, further comprising:
a threshold clamp coupled to a bottom portion of the panel for engagement with a windowsill.

12. The interior-mount protective window covering system of claim 10, wherein the rods are connected via mechanical linkages that
translate movement of the positioning lever into synchronized lateral movement of the securement members.

13. The interior-mount protective window covering system of claim 10, wherein the panel comprises laminated impact-resistant glass rated for hurricane protection, the glass including a polymer interlayer configured to prevent shattering upon impact.

14. The interior-mount protective window covering system of claim 10, wherein each securement member comprises an adjustment slot oriented at a diagonal angle, the adjustment slot being guided along a fixed guide pin secured to the panel, such that movement of the securement member causes the adjustment slot to traverse the guide pin to achieve lateral extension and retraction.

15. A method of using the interior-mount protective window covering system of claim 10, the method comprising:
positioning the panel into the window frame from an interior-facing side;
actuating the positioning lever to simultaneously extend the securement members via the rods;
engaging the threshold clamp against a windowsill; and
closing the window to secure the panel.

16. An interior-mount protective window covering system configured for tool-less installation from within a building, the interior-mount protective window covering system comprising:
a panel sized for placement within a window frame from an interior-facing side of a structure;
a pair of opposing securement members disposed along lateral sides of the panel;
a hollow tube extending laterally through or behind the panel and coupling both securement members;
a spring and plunger assembly positioned within the tube and configured to bias the securement members outward into engagement with the window frame; and
a handle or actuator operatively linked to the plunger assembly to retract the securement members for panel insertion or removal.

17. The interior-mount protective window covering system of claim 16, further comprising:
a threshold clamp disposed along a lower edge of the panel.

18. The interior-mount protective window covering system of claim 16, wherein the tube comprises a pair of internal springs and plungers extending toward opposite ends, each plunger being mechanically linked to a securement member.

19. The interior-mount protective window covering system of claim 16, wherein each end of the tube includes a movable end cap configured to transmit extension and retraction forces to the securement members.

20. A method of using the interior-mount protective window covering system of claim 16, the method comprising:
positioning the panel into the window frame from inside a structure;
releasing the handle to allow spring-driven extension of the securement members;
positioning the threshold clamp onto the windowsill; and
closing the window to retain the panel in position.
